(19) United States
(12) Patent Application Publication
(10) Pub. No.: US 2006/0154818 A1
(43) Pub. Date: Jul. 13, 2006

(54) Polymeric material containing a latent acid

(76) Inventors: Mara Destro, Bologna (IT); Dario Lazzari, Bologna (IT); Dirk Simon, Lorrach-Brombach (DE); James Philip Taylor, Oldham (GB); Manuele Vitali, Bologna (IT); Michael Heneghan, Rheinfelden-Eichsel (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/537,584

(22) PCT Filed: Jan. 12, 2003
(86) PCT No.: PCT/EP03/50912

§ 371 Date: Jan. 9, 2006

(30) Foreign Application Priority Data
Dec. 9, 2002 (GB) 0228647.4

(51) Int. Cl. B41M 5/24

(52) U.S. Cl. 503/201

(57) ABSTRACT

Polymeric material, containing a phenolic antioxidant and/or phenolic UVA and a colour former is unchanged by invisible light and may be coloured by irradiation with energy higher than visible light.

The present application relates to a method of coloring a polymeric material on irradiation using ultraviolet (UV) or high energy radiation, to a polymeric material containing a colour former and a phenolic antioxidant and/or phenolic ultraviolet absorber (UVA) as latent acid, i.e. a compound which is not an acid but which can be converted to an acid by the influence of irradiation, and to some specific uses of this material.

Recently, for real-time marking of letters and signs such as marker's name, product name, date of production, lot number etc. on the surfaces of various commercial articles, the laser marking system is popularly employed for its various advantages. However, the existing laser marking systems do not perfectly fulfill all the user's requirements and thus a need exists to improve the properties of such systems.

Some compositions containing color former and an acidic substance, which change color upon heating with a microwave laser, are shown in U.S. Pat. No. 5,824,715 and EP-A-600441. WO 02/08821 reports a reversible thermochromic effect by combining a chromogenic compoun with certain phenoles.

EP-A-290750 suggests the use of a nitrobenzaldehyde as an acid former in self-coloring, UV sensitive solutions. U.S. Pat. No. 4,343,885 and EP-A-720053 describe some photopolymerizable compositions wherein color former is combined with a diazonium salt and/or certain halogenated compounds. A similar color generation is proposed in U.S. Pat. No. 5,677,107.

It has now been found that phenolic antioxidants or phenolic UVAs present in a polymer matrix may split off a proton on irradiation with energy above visible light, and thus may function as a latent acid able to transform a colour former into a dye (irreversible photo-chromic effect).

Thus, present invention relates to a method of coloring a polymeric material, wherein a polymeric material containing

a) a phenolic antioxidant and/or phenolic UVA and

b) a colour former

is irradiated using a radiation of higher energy than visible light, provided that the phenolic antioxidant and/or phenolic UVA (a) is not a compound of the formula (2) to (14)

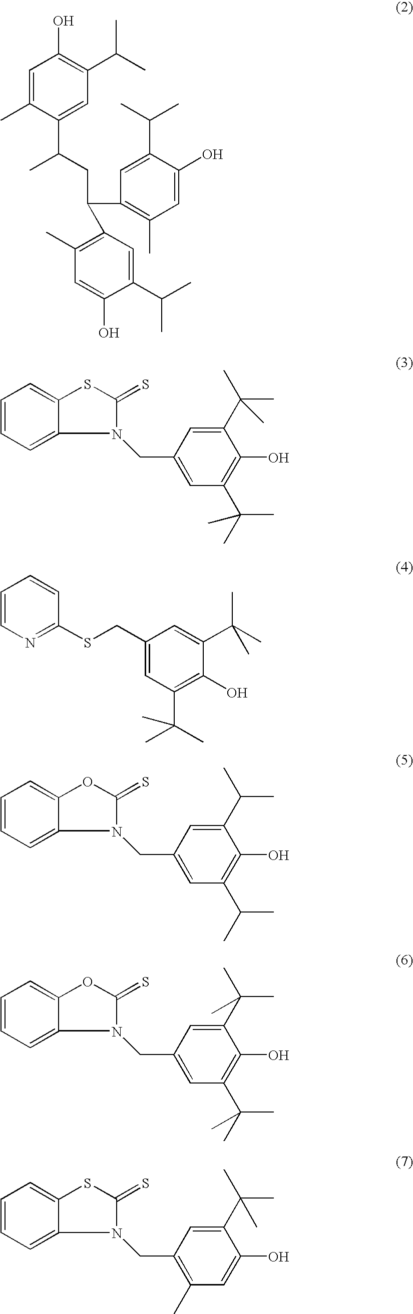

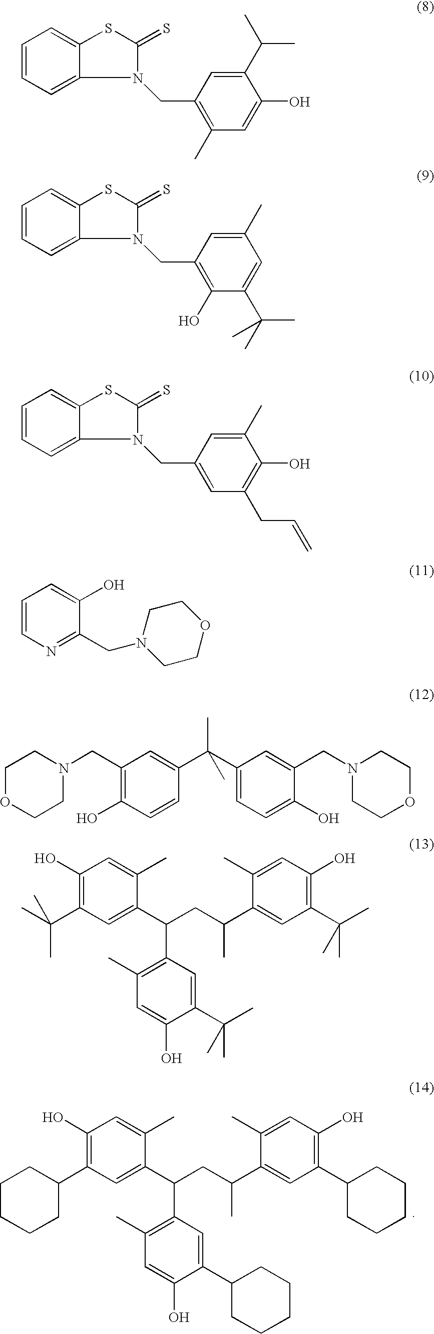

Suitable radiation includes UV light (wavelength (λ) shorter than 400 nm), X-ray, γ-ray, or particle radiation such as electron beam. Preferred radiation sources include UV laser, UV lamp, X-ray or electron radiation sources, radioactive materials emitting α-, β- and/or γ-radiation.

The phenolic antioxidant and/or phenolic UVA (a) is widely known for use in polymeric compositions, e.g. as a processing stabilizer or light stabilizer, and an item of commerce. The molecular weight of the phenolic antioxidant and/or phenolic UVA is preferably 340 g/mol or higher, e.g. from 340 to 1500 g/mol; in a specific embodiment ranging from 400 to 1300 g/mol.

The phenolic compounds, preferably pentaerythrityl-tetrakis(3-[3′,5′-di-tert.butyl-4′-hydroxyphenyl]-propionate), can be used as latent acids.

Typical examples of phenolic UVA are light stabilizers of the hydroxyphenyl-benzotriazole, hydroxyphenyl-triazine or hydroxybenzophenone classes, all comprising a hydroxyl group located on a phenyl ring in ortho-position relative to the phenyl ring's attachment of the core molecule. Examples for such compounds can be found in the below list of compounds conveniently to be used as coadditives under items 2.1, 2.2 and 2.8.

A phenolic antioxidant is preferred as component (a). It usually comprises one or more mono-hydroxyphenyl (i.e. “phenol”) moieties and one or more aliphatic or aromatic substituents or lining groups connecting them, with cyclic moieties present in the compound being purely carbocyclic or selected from those of the formulae (lines denoting bonds)

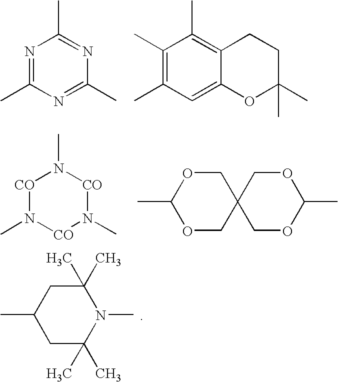

In an important phenolic antioxidant (a) to be used in the method of the invention, each mono-hydroxyphenyl moiety present usually contains

one or two linking bonds to either a group connecting the moiety with 1 to 3 further moieties of the same type (linking group) or to an anchor group,

and optionally 1-3 further substituents, e.g. alkyl of 1 to 12 carbon atoms.

Preferred substituents on the mono-hydroxyphenyl moiety are methyl or tertiary C₄-C₁₂alkyl, especially methyl, tert.-butyl and tert.-pentyl.

Linking groups are usually di-, tri- or tetravalent aliphatic groups of 1 to 20 carbon atoms, such as divalent groups selected from alkylene which may be interrupted and/or end-capped with —O—, —NH—, —S—, —CO—, —COO—, —OCO—, —NHCO—, —CONH—, a group L₁, phenylene, phenylene which is substituted by C₁-C₁₂alkyl and/or C₁-C₁₂alkoxy and/or C₂-C₁₂alkanoyloxy and/or C₃-C₁₂alkenoyloxy;

divalent mono-, di- or tricycloalkylene groups; divalent mono-, di- or tricycloalkylene groups interrupted by —O—; spacer groups —O—; —NH—; —S—; —CO—; —COO—; —OCO—; —NHCO—; —CONH—;

trivalent groups selected from

trivalent alkyl groups of 3 to 20 carbon atoms; said trivalent alkyl groups interrupted and/or end-capped with —O—, —NH—, —S—, —CO—, —COO—, —OCO—, —NHCO—, —CONH—, a group L₁, phenylene, phenylene which is substituted by C₁-C₁₂alkyl and/or C₁-C₁₂alkoxy and/or C₂-C₁₂alkanoyloxy and/or C₃-C₁₂alkenoyloxy; or trivalent groups of the formulae 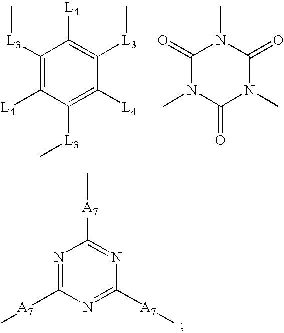
tetravalent alkyl groups of 4 to 20 carbon atoms; said tetravalent alkyl groups interrupted and/or end-capped with —O—, —NH—, —S—, —CO—, —COO—, —OCO—, —NHCO—, —CONH—, a group L₁, phenylene, phenylene which is substituted by C₁-C₁₂alkyl and/or C₁-C₁₂alkoxy and/or C₂-C₁₂alkanoyloxy and/or C₃-C₁₂alkenoyloxy;
L₁ is a group selected from the formulae 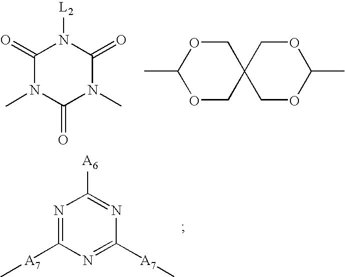
L₂ is OH, C₁-C₁₂alkyl, C₁-C₁₂alkoxy, C₂-C₁₂hydroxyalkyl; C₂-C₁₂hydroxyalkoxy;
L₃ independently are C₁-C₄alkylene;
L₄ independently are H or C₁-C₄alkyl; and
A₆ and A₇ are as defined for anchor groups below.

Anchor groups are usually selected from
C₁-C₂₂alkyl; C₁-C₂₂alkyl-A₅-; C₂-C₂₂alkyl interrupted by -A₅-; -A₄-phenyl; -A₄-phenyl where the phenyl core is substituted by C₁-C₁₂alkyl, C₁-C₁₂alkoxy, C₂-C₁₂alkanoyloxy and/or C₃-C₁₂alkenoyloxy; C₁-C₈alkyl substituted by a group of the formula 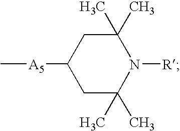
phosphite, phosphate or phosphonate ester groups, e.g. of the formula
-A₃-(O)ₘ—P(═O)ₚ(OA₁)(OA₂);
or the anchor group is of the formula 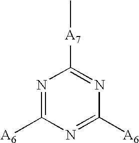
where m and p independently are 0 or 1;
A₁ and A₂ independently are C₁-C₁₂alkyl or phenyl or phenyl substituted by C₁-C₁₂alkyl or an equivalent of an alkaline, alkaline earth or aluminum atom;
A₃ is a direct bond or C₁-C₆alkylene;
A₄ is selected from C₁-C₆alkylene and A₅;
A₅ is selected from —O—, —NH—, —S—, —CO—, —COO—, —OCO—, —NHCO—, —CONH—;
A₆ is selected from C₁-C₁₈alkoxy, C₁-C₁₈alkylthio and C₁-C₁₈alkylamino;
A₇ is —O— or —NH—;
R′ is H, C₁-C₁₈alkyl, C₁-C₁₈alkoxy or cyclohexyloxy:
or the anchor group is C₃-C₂₂alkylene or C₃-C₂₂oxaalkylene attached with both open bonds to adjacent carbon atoms of the mono-hydroxyphenyl moiety.

If the anchor group is attached to the phenol moiety by a carbon atom, this carbon atom is preferably quaternary carbon (i.e. carbon containing no bond to hydrogen).

Component (a) can also be a phenolic UV absorber compound selected from benzotriazoles of the formula (IIa), 2-hydroxybenzophenones of the formula (IIb), 2-hydroxyphenyltriazines of formula (IIc): 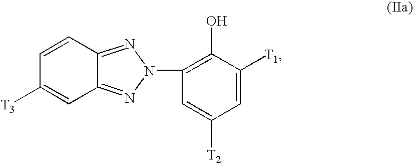
wherein T₁ is hydrogen, C₁-C₁₈alkyl, or C₁-C₁₈alkyl which is substituted by phenyl,
or T₁ is a group of the formula 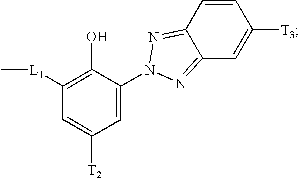
L₁ is a divalent group, for example —(CH₂)ₙ—, where n is from the range 1-8;
T₂ is hydrogen, C₁-C₁₈alkyl, or is C₁-C₁₈alkyl which is substituted by COOT₅, C₁-C₁₈alkoxy, hydroxyl, phenyl or C₂-C₁₈acyloxy;
T₃ is hydrogen, halogen, C₁-C₁₈alkyl, C₁-C₁₈alkoxy, C₂-C₁₈acyloxy, perfluoroalkyl of 1 to 12 carbon atoms such as —CF₃, or T₃ is phenyl;
T₅ is C₁-C₁₈alkyl or C₄-C₅₀alkyl interrupted by one or more O and/or substituted by OH or by a group; 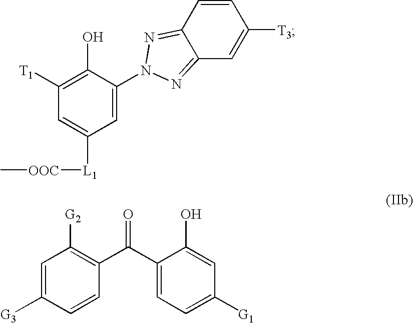
wherein
G₁, G₂ and G₃ independently are hydrogen, hydroxy or C₁-C₁₈alkoxy; 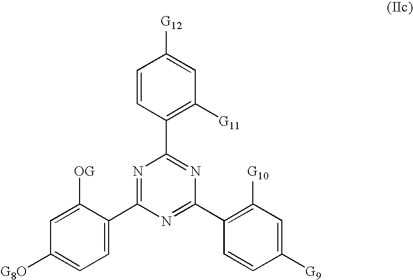
wherein
G₈ is C₁-C₁₈alkyl, or is C₄-C₁₈alkyl which is interrupted by COO or OCO or O, or is interrupted by O and substituted by OH;
G₉, G₁₀, G₁₁ and G₁₂ independently are hydrogen, methyl, hydroxy or OG₈; and G₉ and G₁₂ also comprise phenyl.

Preferred anchor groups are tertiary C₄-C₁₂alkyl; C₁-C₂₂alkyl-A₅-; C₂-C₂₂alkyl interrupted by -A₅-; -A₅-phenyl; -A₅-phenyl where the phenyl core is substituted by C₁-C₁₂alkyl; -A₄-phenyl where the phenyl core is substituted by C₂-C₁₂alkanoyloxy and/or C₃-C₁₂alkenoyloxy, and optionally further by C₁-C₁₂alkyl; or the anchor group is C₃-C₂₂alkylene or C₃-C₂₂oxaalkylene attached with both open bonds to adjacent carbon atoms of the mono-hydroxyphenyl moiety; or is a group of one the formulae 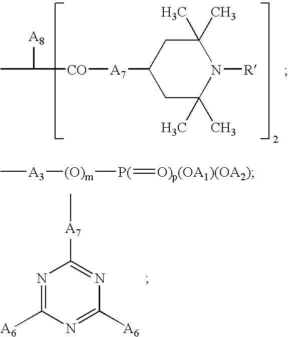
where m and p independently are 0 or 1;
A₁ and A₂ independently are C₁-C₁₂alkyl or phenyl or phenyl substituted by C₁-C₁₂alkyl or an equivalent of an alkaline, alkaline earth or aluminum atom;
A₃ is a direct bond or C₁-C₆alkylene;
A₄ is selected from C₁-C₈alkylene, —O—, —NH—, —S—, —CO—, —COO—, —CO—, —NHCO—, —CONH—;
A₅ is selected from —O—, —NH—, —S—, —CO—, —COO—, —OCO—, —NHCO—, —CONH—;
A₆ is selected from C₁-C₁₈alkoxy, C₁-C₁₈alkylthio and C₁-C₁₈alkylamino;
A₇ is O or —NH—;
A₈ is C₁-C₇alkyl;
R′ is C₁-C₁₈alkyl.

Anchor or linking groups often contain one or more spacers such as —O—, —NH—, —S—, —CO—, —COO—, —OCO—, —NHCO—, —CONH—, phenylene, or substituted phenylene; these groups may be linked together; however, usually no —O—O-(peroxo) or —NH—O— or —NH—S— or —O—S— linkage is formed.

Alkylene groups end-capped by A₅ are, for example, -alkylene-A₅-, -A₅-alkylene, -A₅-alkylene-A₅-.

R′ is preferably C₁-C₁₈alkyl, especially methyl.

In phosphite, phosphate or phosphonate ester groups, A₁ and A₂ independently preferably are C₁-C₁₂alkyl an equivalent of an alkaline, alkaline earth or aluminum atom.

Preferred salts are those wherein only one of A₁ and A₂ is an equivalent of a metal atom, e.g. selected from Li, Na, K, ½ Mg, ½ Ca, ⅓ Al, especially ½ Ca. More preferred are phosphates where p is 1, especially phosphonates where m is 0 and p is 1 or corresponding salts.

Thus, the phenolic antioxidant (a) is preferably of the formula (A) 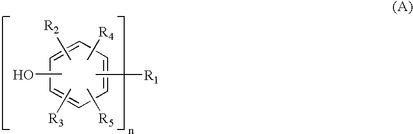
wherein
R₂, R₃, R₄ and R₅ independently are hydrogen, methyl or tertiary C₄-C₁₂alkyl, especially methyl, tert.-butyl and tert.-pentyl;
n is from the range 1-4:
when n is 1,
R₁ is tertiary C₄-C₁₂alkyl; C₁-C₂₂alkyl-A₅-; C₂-C₂₂alkyl interrupted by -A₅-; -A₅-phenyl; -A₅-phenyl where the phenyl core is substituted by C₁-C₁₂alkyl; -A₄-phenyl where the phenyl core is substituted by C₂-C₁₂alkanoyloxy and/or C₃-C₁₂alkenoyloxy, and optionally further by C₁-C₁₂alkyl; or R₁ together with Re is C₃-C₂₂alkylene or C₃-C₂₂oxaalkylene attached with both open bonds to adjacent carbon atoms of the mono-hydroxyphenyl moiety; or is a group of one the formulae 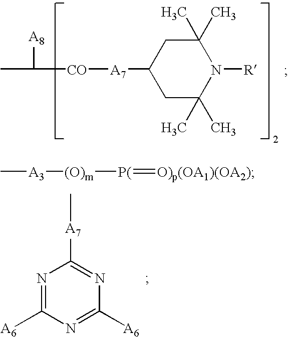
where m and p independently are 0 or 1;
A₁ and A₂ independently are C₁-C₁₂alkyl or phenyl or phenyl substituted by C₁-C₁₂alkyl or an equivalent of an alkaline, alkaline earth or aluminum atom;
A₃ is a direct bond or C₁-C₈alkylene;
A₄ is selected from C₁-C₈alkylene, —O—, —NH—, —S—, —CO—, —COO—, —OCO—, —NHCO—, —CONH—;
A₅ is selected from —O—, —NH—, —S—, —CO—, —COO—, —OCO—, —NHCO—, —CONH—;
A₆ is selected from C₁-C₁₈alkoxy, C₁-C₁₈alkylthio and C₁-C₁₈alkylamino;
A₇ is —O— or —NH—;
A₈ is C₁-C₇alkyl;
R′ is C₁-C₁₈alkyl;
when n is 2, R₁ is C₁-C₂₀alkylene which may be interrupted and/or end-capped with —O—, —NH—, —S—, —CO—, —COO—, —OCO—, —NHCO—, —CONH—, -L₁-, phenylene, phenylene which is substituted by C₁-C₁₂alkyl and/or C₁-C₁₂alkoxy and/or C₂-C₁₂alkanoyloxy and/or C₃-C₁₂alkenoyloxy;
divalent mono-, di- or tricycloalkylene groups; divalent mono-, di- or tricycloalkylene groups interrupted by —O—; spacer groups —O—; —NH—; —S—; —CO—; —COO—; —OCO—; —NHCO—; —CONH—;
when n is 3, R₁ is trivalent alkyl of 3 to 20 carbon atoms; said trivalent alkyl interrupted or end-capped with —O—, —NH—, —S—, —CO—, —COO—, —OCO—, —NHCO—, —CONH—, -L₁-, phenylene, phenylene which is substituted by C₁-C₁₂alkyl and/or C₁-C₁₂alkoxy and/or C₂-C₁₂alkanoyloxy and/or C₃-C₁₂alkenoyloxy; or trivalent groups of the formulae 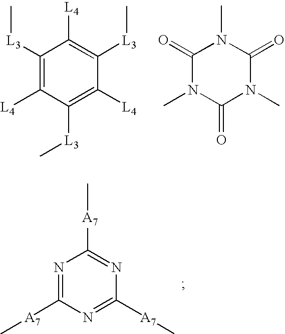
when n is 4, R₁ is tetravalent alkyl of 4 to 20 carbon atoms; said tetravalent alkyl interrupted or end-capped with —O—, —NH—, —S—, —CO—, —COO—, —OCO—, —NHCO—, —CONH—, -L₁-, phenylene, phenylene which is substituted by C₁-C₁₂alkyl and/or C₁-C₁₂alkoxy and/or C₂-C₁₂alkanoyloxy and/or C₃-C₁₂alkenoyloxy;
L₁ is a group selected from the formulae 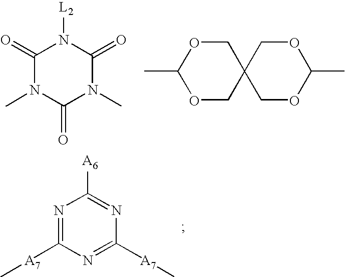
L₂ is OH, C₁-C₁₂alkyl, C₁-C₁₂alkoxy, C₂-C₁₂hydroxyalkyl; C₂-C₁₂hydroxyalkoxy;
L₃ independently are C₁-C₄alkylene;
L₄ independently are H or C₁-C₄alkyl.

Especially preferred are those wherein

R₂, R₃, R₄ and R₅ independently are hydrogen, methyl, tert.-butyl, tert.-pentyl;

when n is 1,

R₁ is tertiary butyl, tertiary pentyl; C₁-C₂₂alkyl-A₅-; C₂-C₂₂alkyl interrupted by -A₅-; -A₅-phenyl where the phenyl core is substituted by C₁-C₁₂alkyl; -A₄-phenyl where the phenyl core is substituted by C₃-C₄alkenoyloxy and C₁-C₁₂alkyl; or R₁ together with R₅ is C₃-C₂₂alkylene or C₃-C₂₂oxaalkylene attached with both open bonds to adjacent carbon atoms of the mono-hydroxyphenyl moiety; or R₁ is a group of one the formulae 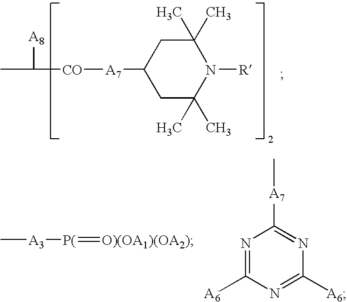
A₁ and A₂ independently are C₁-C₄alkyl or an equivalent of a metal atom selected from Li, Na, K, ½ Mg, ½ Ca, ⅓ Al;
A₃ is methylene;
A₄ is C₁-C₆alkylene;
A₅ is selected from —O—, —S—, —COO—, —OCO—, —NHCO—, —CONH—;
A₆ is selected from C₄-C₁₈alkylthio and C₄-C₁₈alkylamino;
A₇ is —NH—;
A₈ is C₁-C₇alkyl;
R′ is C₁-C₁₈alkyl;
when n is 2, R₁ is C₁-C₁₂alkylene; C₂-C₂₀alkylene interrupted and/or end-capped with —O—, —S—, —COO—, —OCO—, —NHCO—, —CONH—, -L₁-; or R₁ is a divalent mono-, di- or tricycloalkylene group; or R₁ is —O—; —NH—; —S—;
when n is 3, R₁ is trivalent alkyl of 3 to 20 carbon atoms; said trivalent alkyl interrupted by —O—, —S—, —COO—, —OCO—, —NHCO—, —CONH—, phenylene, phenylene which is substituted by C₁-C₁₂alkyl; or R₁ is a trivalent group of one of the formulae 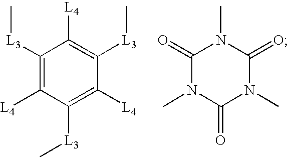
when n is 4, R₁ is tetravalent alkyl of 4 to 20 carbon atoms; or said tetravalent alkyl interrupted by —O—, —S—, —COO—, —OCO—, —NHCO—, —CONH—;
L₁ is a group of the formula 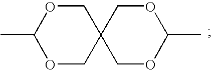
L₃ independently are C₁-C₄alkylene;
L₄ independently are H or C₁-C₄alkyl.

In particularly preferred phenolic antioxidants, each mono-hydroxyphenyl moiety contains one or preferably two aliphatic substituents, e.g. methyl, tert.-butyl, tert.-pentyl, at least one thereof being located in ortho-position relative to the phenolic OH.

Phenolic antioxidants useful in the present invention include the compounds listed below:

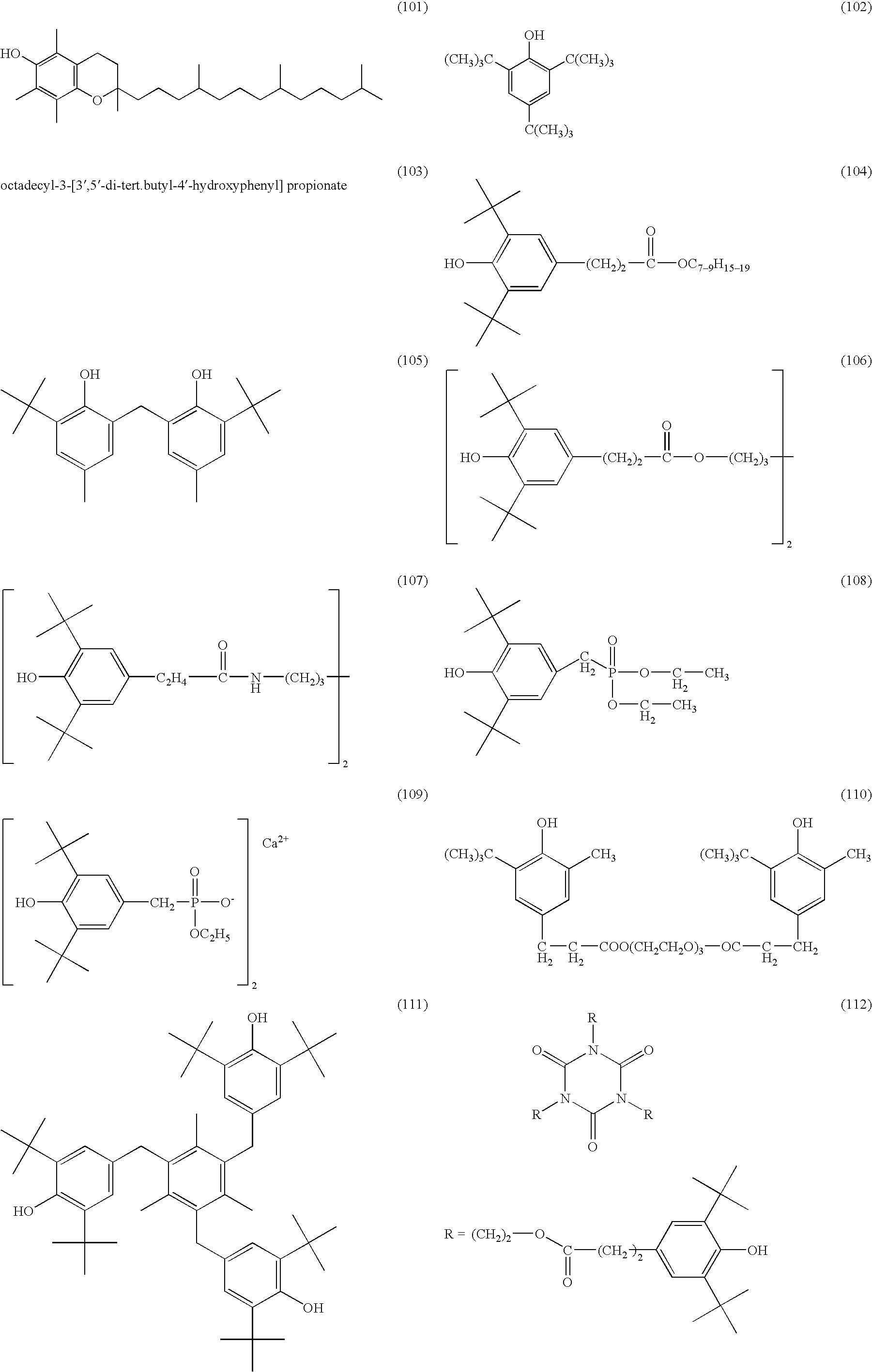

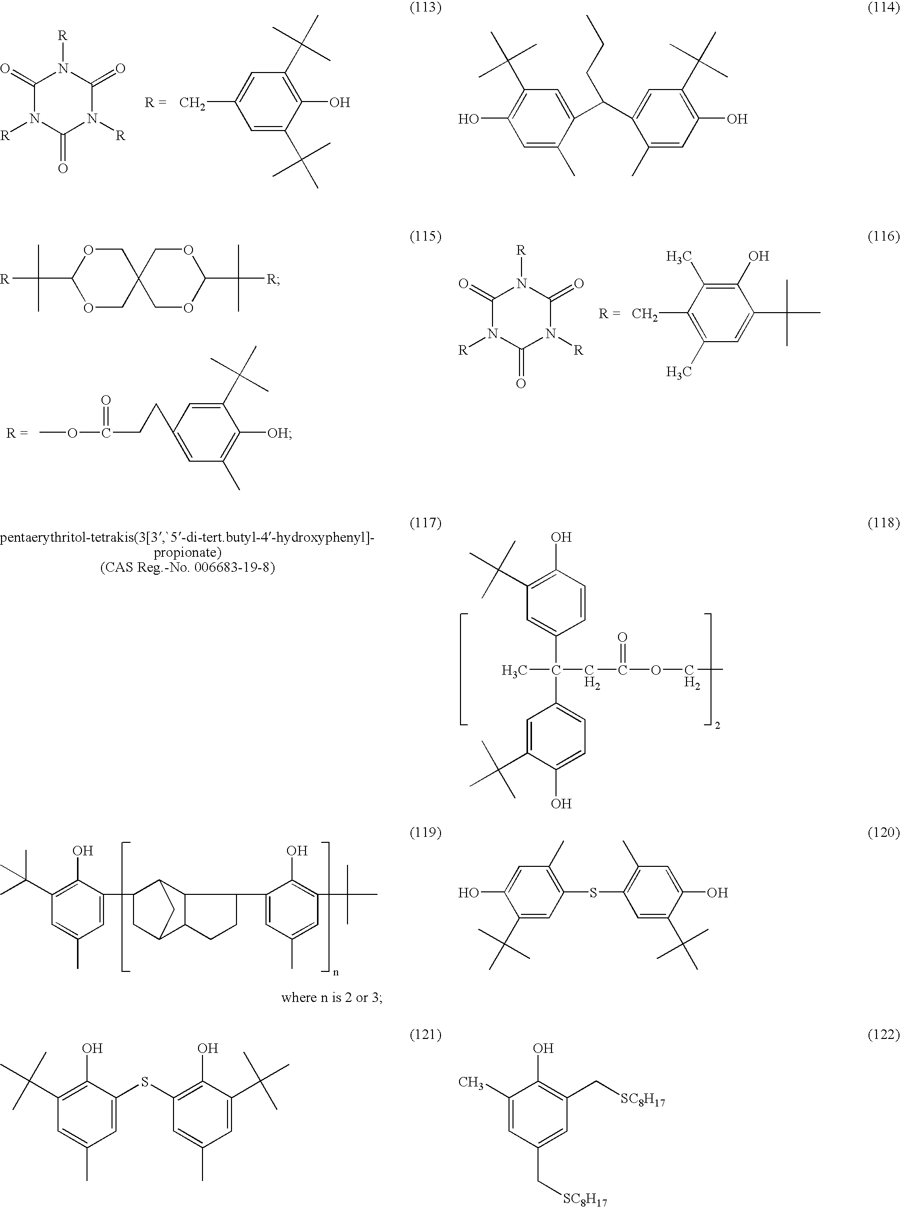

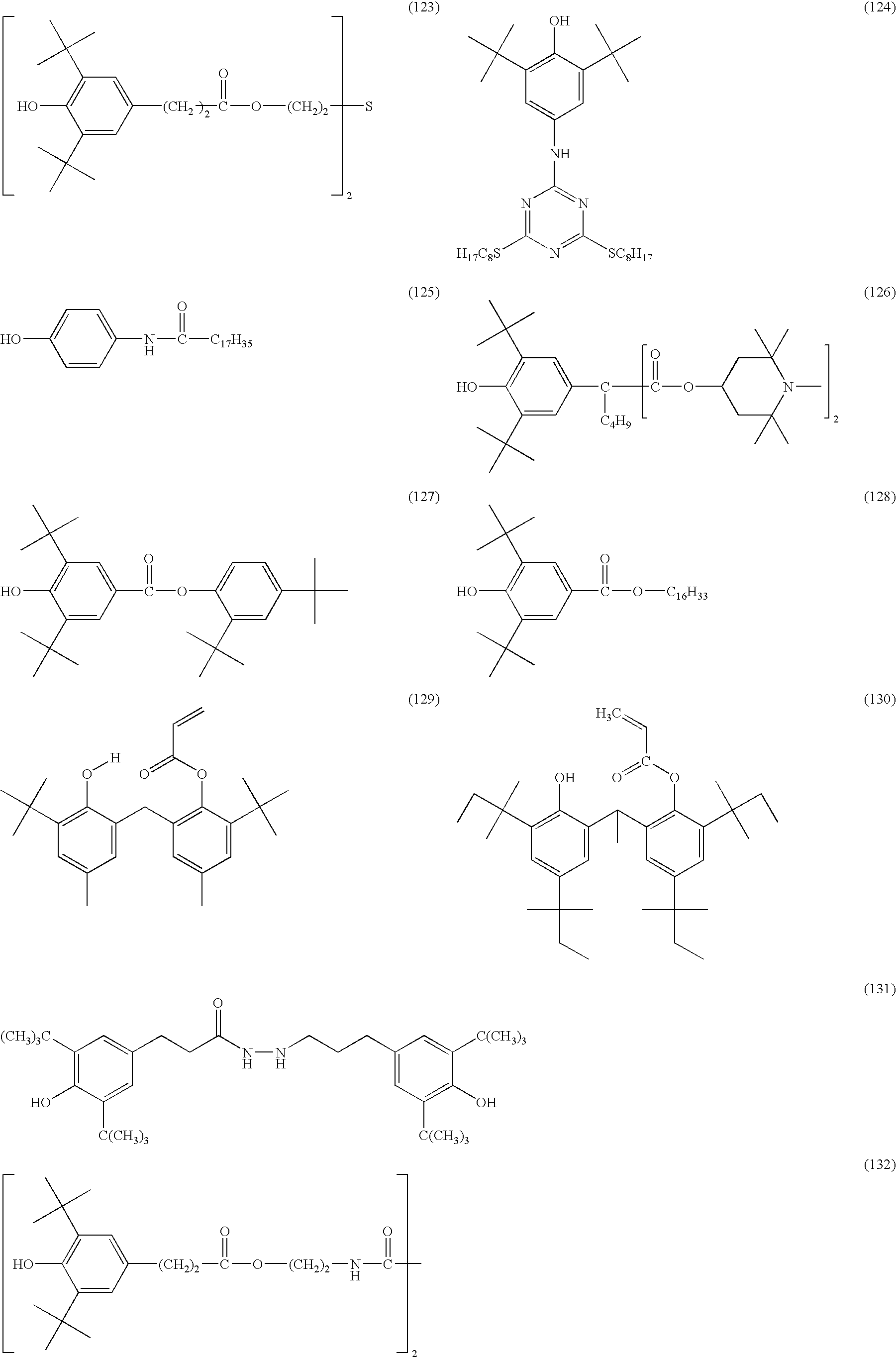

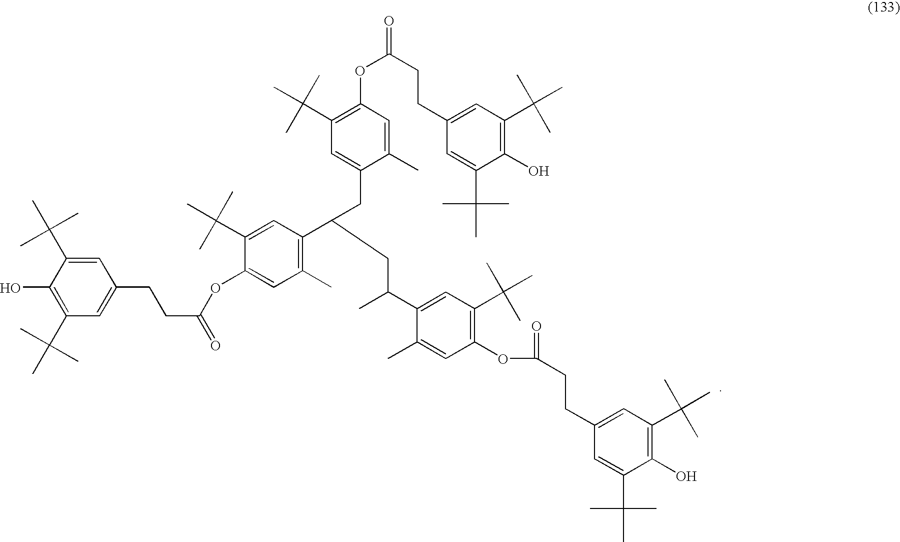

The phenolic antioxidant and/or phenolic UVA (a) is preferably not of the formula 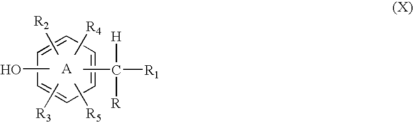
wherein ring A can contain one or more hetero atoms and/or can contain an anelated ring,
R₁ is hydrogen, alkyl, alkenyl, aryl,
R₂, R₃, R₄ and R₅ independently of each other are hydrogen or a functional substituent, and
R stands for C₁-C₆alkyl, -Z₁-Q₁, or -Z₂-Q₂,
wherein Z₁ is a single bond, S, NH or O, and Q₁ is a heterocyclic ring system having from 5 to 9 ring atoms selected from C, S, O and N, with at least 2 carbon atoms in the ring system, preferably Q₁ stands for morpholine, pyridine, which may be substituted one to three times with C₁-C₄alkyl or hydroxy, mercaptobenzoxazole, mercaptobenzthiazole,
and wherein Z₂ stands for C₁-C₄alkylene, which can be substituted by C₁-C₄alkyl or Q₃,
wherein Q₃ stands for phenyl which can be substituted one to three times with C₁-C₄alkyl, hydroxy, C₅-C₈cycloalkyl and/or a heterocyclic ring system having from 5 to 9 ring atoms selected from C, S, O and N, with at least 2 carbon atoms in the ring system, and Q₂ stands for phenyl which can be substituted one to three times with C₁-C₄alkyl, hydroxy, C₅-C₈cycloalkyl and/or a heterocyclic ring system having from 5 to 9 ring atoms selected from C, S, O and N, with at least 2 carbon atoms in the ring system, such as compounds of the formula X wherein the H at the C-atom in α-position to R can be split off by irradiation.

Halogen means fluoro, chloro, bromo, or iodo, preferably chloro.

It is furthermore preferred that at least one of R₂ and R₃ is in o-position to the OH-group.

C₁-C₂₂-alkyl means, for example, methyl, ethyl, n-, i-propyl, n-, sec.-, iso-, tert.-butyl, n-pentyl, tert.-pentyl, n-hexyl, n-heptyl, n-octyl, tert.-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl.

C₂-C₂₀-alkenyl stands for e.g. ethenyl, n-, l-propenyl, n-, sec.-, iso-, tert.-butenyl, n-pentenyl, n-hexenyl, n-heptenyl, n-octenyl, n-nonenyl, n-decenyl, n-undecenyl, n-dodecenyl, n-tridecenyl, n-tetradecenyl, n-pentadecenyl, n-hexadecenyl, n-heptadecenyl, n-octadecenyl, n-nonadecenyl, n-eicosenyl, preferably C₂-C₆alkyl such as ethenyl, n-, l-propenyl, n-, sec.-, iso-, tert.-butenyl, n-pentenyl, n-hexenyl.

C₅-C₈-cycloalkyl stands for cyclopentyl, cyclohexyl, cycloheptyl, or cyclooctyl, preferably cyclohexyl. Examples for di- or tricycloalkyl groups are bicycloheptyl or

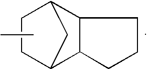

Di-, tri- or tetravalent residues may be derived from the corresponding monovalent units, e.g. those listed above, by abstraction of 1, 2 or 3 further hydrogen atoms.

C₁-C₆-alkoxy stands for e.g. methoxy, ethoxy, n-, i-propoxy, n-, sec.-, iso-, tert.-butoxy, n-pentoxy, n-hexoxy.

C₂-C₁₂alkanoyloxy includes, for example acetyloxy, propionyloxy; C₃-C₁₂alkenoyloxy includes acryloyloxy, methacryloyloxy.

Polymeric material useable for the present invention is preferably synthetic organic polymeric material, for example material commonly used for electronic applications.

In particular the following polymers are preferred:

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (LDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).
   2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).
   3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic add copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.
   4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(α-methylstyrene).

6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

6a. Copolymers including aforementioned vinyl aromatic monomers and comonomers selected from ethylene, propylene, dienes, nitriles, adds, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bisglycidyl ethers.

13. Polyacetals such as polyoxymethylene and those polyoxymethylenes, which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimids, polyesterimids, polyhydantoins and polybenzimidazoles.

18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.

19. Polycarbonates and polyester carbonates.

20. Polyketones.

21. Polysulfones, polyether sulfones and polyether ketones.

22. Crosslinked polymers derived from aldehydes on the one hand and phenols, ureas and melamines on the other hand, such as phenol/formaldehyde resins, urea/formaldehyde resins and melamine/formaldehyde resins.

23. Drying and non-drying alkyd resins.

24. Unsaturated polyester resins derived from copolyesters of saturated and unsaturated dicarboxylic acids with polyhydric alcohols and vinyl compounds as crosslinking agents, and also halogen-containing modifications thereof of low flammability.

25. Crosslinkable acrylic resins derived from substituted acrylates, for example epoxy acrylates, urethane acrylates or polyester acrylates.

26. Alkyd resins, polyester resins and acrylate resins crosslinked with melamine resins, urea resins, isocyanates, isocyanurates, polyisocyanates or epoxy resins.

27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.

28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

29. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

Preferred organic polymeric materials are synthetic thermoplastic materials, especially transparent ones.

Especially preferred is organic polymeric material made of SAN (copolymer made of styrene and acrylonitrile), polyolefin such as PP (polypropylene) or PE (polyethylene), PVC (polyvinylchloride), polychlorobutadiene, polyesters such as PET (polyethyleneterephthalate), PET-G (glycol modified PET), PMMA (polymethylmethacrylate) and related polyacrylics, PS (polystyrene), ASA (copolymer made of acrylonitrile, styrene, acrylate), PA (polyamide), ABS (copolymer made of acrylonitrile, styrene, butadiene), LLDPE (linear LDPE), LDPE (low density polyethylene), HDPE (high density polyethylene) and polycarbonate, most preferably polycarbonate. The polymeric material can also be a mixture (blend) of two or more polymers, e.g. polyester or PET-G/polycarbonate blends. Most preferred are transparent articles made from polycarbonate, polyester, PET-G, polyester or PET-G blends with polycarbonate, PVC, PE, PP, polyacrylics, polystyrene, such as films or sheets of these polymers or blends or alloys thereof.

The colour forming compounds are, for example, triphenylmethanes, lactones, benzoxazines, spiropyrans or preferably fluorans or phthalides.

Suitable colour formers include but are not limited to: 3-dibutylamino-7-dibenzylaminofluoran, 3-diethylamino-6-methylfluoran, 3-dimethylamino-6-methyl-7-anilinofluoran, 3-diethylamino-6-methyl-7-anilinofluoran, 3-diethylaminomethyl-7-(2,4-dimethylanilino)fluoran, 3-diethylamino-6-methyl-7-chlorofluoran, 3-diethylamino-6-methyl-7-(3-trifluoromethylanilino)fluoran, 3-diethylamino-6-methyl-7-(2-chloroanilino)fluoran, 3-diethylamino-6-methyl-7-(4-chloroanilino)fluoran, 3-diethylamino-6-methyl-7-(2-fluoroanilino)fluoran, 3-diethylamino-6-methyl-7-(4-n-octylanilino)fluoran, 3-diethylamino-7-(4-n-octylanilino)fluoran, 3-diethylamino-7-(4-n-octylamino)fluoran, 3-diethylamino-6-methyl-7-(dibenzylamino)fluoran, 3-diethylamino-7-(dibenzylamino)fluoran, 3-diethylamino-6-chloro-7-methylfluoran, 3-diethylamino-7-t-butylfluoran, 3-diethylamino-7-carboxyethylfluoran, 3-diethylamino-6-chloro-7-anilinofluoran, 3-diethylamino-6-methyl-7-(3-methylanilino)fluoran, 3-diethylamino-6-methyl-7-(4-methylanilino)fluoran, 3-diethylamino-6-ethoxyethyl-7-anilinofluoran, 3-diethylamino-7-methylfluoran, 3-diethylamino-7-chlorofluoran, 3-diethylamino-7-(3-trifluoromethylanilino)fluoran, 3-diethylamino-7-(2-chloroanilino)fluoran, 3-diethylamino-7-(2-fluoroanilino)fluoran, 3-diethylamino-benzo[a]fluoran, 3-diethylamino-benzo[c]fluoran, 3-dibutylamino-6-methyl fluoran, 3-dibutylamino-6-methyl-7-anilinofluoran, 3-dibutylamino-6-methyl-7-(2,4-dimethylanilino)fluoran, 3-dibutylamino-6-methyl-7-(2-chloroanilino)fluoran, 3-dibutylamino-6-methyl-7-(4-chloroanilino)fluoran, 3-dibutylamino-6-methyl-7-(2-fluoroanilino)fluoran, 3-dibutylamino-6-methyl-7-(3-trifluoromethylanilino)fluoran, 3-dibutylamino-ethoxyethyl-7-anilinofluoran, 3-dibutylamino-6-chloro-anilinofluoran, 3-dibutylamino-6-methyl-7-(4-methylanilino)fluoran, 3-dibutylamino-7-(2-chloroanilino)fluoran, 3-dibutylamino-7-(2-fluoroanilino)fluoran, 3-dipentylamino-6-methyl-7-anilinofluoran, 3-dipentylamino-6-methyl-7-(4-2-chloroanilino)fluoran, 3-dipentylamino-7-(3-trifluoromethylanilino)fluoran, 3-dipentylaminochloro-7-anilinofluoran, 3-dipentylamino-7-(4-chloroanilino)fluoran, 3-pyrrolidino-6-methyl-7-anilinofluoran, 3-piperidino-6-methyl-7-anilinofluoran, 3-(N-methyl-N-propylamino)-6-methyl-7-anilinofluoran, 3-(N-methyl-N-cyclohexylamino)-6-methyl-7-anilinofluoran, 3-(N-ethyl-N-cyclohexylamino)-6-methyl-7-anilinofluoran, 3-(N-ethyl-p-toluidino)-6-methyl-7-anilinofluoran, 3-(N-ethyl-N-isoamylamino)-6-methyl-7-anilinofluoran, 3-(N-ethyl-N-isoamylamino)-6-chloro-7-anilinofluoran, 3-(N-ethyl-N-tetrahydrofurfurylamino)-6-methyl-7-anilinofluoran, 3-(N-ethyl-N-isobutylamino)-6-methyl-7-anilinofluoran, 3-(N-butyl-isoamylamino)-6-methyl-7-anilinofluoran, 3-(N-isopropyl-N-3-pentylamino)-6-methyl-7-anilinofluoran, 3-(N-ethyl-N-ethoxypropylamino)-6-methyl-7-anilinofluoran, 3-cyclohexylamino-6-chlorofluoran, 2-methyl-6-p-(dimethylaminophenyl)aminoanilinofluoran, 2-methoxy-6-p-(p-dimethylaminophenyl)aminoanilinofluoran, 2-chloro-3-methyl-6-p-(p-phenylaminophenyl)aminoanilinofluoran, 2-diethylamino-6-p-(p-dimethylaminophenyl)-aminoanilinofluoran, 2-phenylmethyl-6-p-(p-phenylaminophenyl)aminoanilinofluoran, 2-benzyl-6-p-(p-phenylaminophenyl)aminoanilinofluoran, 3-methyl-6-p-(p-dimethylaminophenyl)aminoanilinofluoran, 3-diethylamino-6-p-(p-diethylaminophenyl)aminoanilinofluoran, 3-diethylamino-6-p-(p-dibutylaminophenyl)aminoanilinofluoran, 2,4-dimethyl-6-[(4-dimethylamino)anilino]fluoran, 3,6,6′-tris(dimethylamino)spiro[fluorene-9,3′-phthalide], 3,6,6′-tris(diethylamino)spiro[fluorene-9,3′-phthalide], 3,3-bis(p-dimethylaminophenyl)-6-dimethylaminophthalide, 3,3-bis(p-dimethylaminophenyl)phthalide, 3,3-bis-[2-(p-dimethylaminophenyl)-2-(p-methoxyphenyl)ethenyl-4,5,6,7-tetrabromophthalide, 3,3-bis-[2-(p-dimethylaminophenyl)-2-(p-methoxyphenyl)ethenyl-4,5,6,7-tetrachlorophthalide, 3,3-bis[1,1-bis(4-pyrrolidinophenyl)ethylene-2-yl]-4,5,6,7-tetrabromophthalide, 3,3-bis-[1-(4-methoxyphenyl)-1-(4-pyrridinophenyl)ethylene-2-yl]-4,5,6,7-tetrachlorophthalide, 3-(4-diethylamino-2-ethoxyphenyl)-3-(1-ethyl-2-methylindole-3-yl)-4-azaphthalide, 3-(4-diethylamino-2-ethoxyphenyl)-3-(1-octyl-2-methylindole-3-yl)-4-azaphthaliden, 3-(4-cyclohexylethylamino-2-methoxyphenyl)-3-(1-ethyl-2-methylindole-3-yl)-4-azaphthalide, 3,3-bis(1-ethyl-2-methylindole-3-yl) phthalide, 3,3-bis(1-octyl-2-methylindole-3-yl) phthalide, mixture of 2-phenyl-4-(4-diethylaminophenyl)-4-(4-methoxyphenyl)-6-methyl-7-dimethylamino-3,1-benzoxazine and 2-phenyl-4-(4-diethylaminophenyl)-4-(4-methoxyphenyl)-8-methyl-7-dimethylamino-3,1-benzoxazine, 4,4′-[1-methylethylidene)bis(4,1-phenyleneoxy-4,2-quinazolinediyl)]bis[N,N-diethylbenzenamine], bis(N-methyldiphenylamine)-4-yl-(N-butylcarbazole)-3-yl-methane.

Especially preferred fluoran compounds are 3-diethylaminobenzo[a]fluoran, 3-(4-diethylamino-2-ethoxyphenyl)-3-(1-ethyl-2-methylindole-3-yl)-4-azaphthalide, 3-(4-diethylamino-2-ethoxyphenyl)-3-(1-octyl-2-methylindole-3-yl)-4-azaphthalide, 3-(4-cyclohexylethylamino-2-methoxyphenyl)-3-(1-ethyl-2-methylindole-3-yl)-4-azaphthalide, 3,3-bis(1-ethyl-2-methylindole-3-yl) phthalide, 3,3-bis(1-octyl-2-methylindole-3-yl) phthalide, mixture of 2-phenyl-4-(4-diethylaminophenyl)-4-(4-methoxyphenyl)-6-methyl-7-dimethylamino-3,1-benzoxazine and 2-phenyl-4-(4-diethylaminophenyl)-4-(4-methoxyphenyl)-8-methyl-7-dimethylamino-3,1-benzoxazine, 4,4′-[1-methylethylidene)bis(4,1-phenyleneoxy-4,2-quinazolinediyl)]bis[N,N-diethylbenzenamine], bis(N-methyldiphenylamine)-4-yl-(N-butylcarbazole)-3-yl-methane, 3-methyl-6-p-(p-dimethylaminophenyl)aminoanilinofluoran, 3-diethylamino-6-p-(p-diethylaminophenyl)aminoanilinofluoran, 3-diethylamino-6-p-(p-dibutylaminophenyl)aminoanilinofluoran, 2,4-dimethyl-6-[(4-dimethylamino)anilino]fluoran, 3,6,6′-tris(dimethylamino)spiro[fluorene-9,3′-phthalide], 3,6,6′-tris(diethylamino)spiro[fluorene-9,3′-phthalide], 3,3-bis(p-dimethylaminophenyl)-6-dimethylaminophthalide, 3,3-bis(p-dimethylaminophenyl)phthalide, 2-diethylamino-6-p-(p-dimethylaminophenyl)aminoanilinofluoran, 3-dibutylaminomethyl-7-(N-formylmethylamino)-fluoran, 2-methyl-6-p-(p-dimethylaminophenyl)aminoanilinofluoran, 2-methoxy-6-p-(p-dimethylaminophenyl)aminoanilinofluoran, 3-(N-ethyl-N-ethoxypropylamino)methyl-7-anilinofluoran, 3-(N-ethyl-N-tetrahydrofurfurylamino)-6-methyl-7-anilinofluoran, 3-(N-ethyl-N-isobutylamino)-6-methyl-7-anilinofluoran, 3-(N-methyl-N-propylamino)-6-methyl-7-anilinofluoran, 3-(N-methyl-N-cyclohexylamino)-6-methyl-7-anilinofluoran, 3-(N-ethyl-N-cyclohexylamino)-6-methyl-7-anilinofluoran, 3-(N-ethyl-p-toluidino)-6-methyl-7-anilinofluoran, 3-(N-ethyl-N-isoamylamino)-6-methyl-7-anilinofluoran, 3-dipentylamino-6-methyl-7-anilinofluoran, 3-dibutylamino-6-methyl-7-anilinofluoran, 3-diethylamino-7-methylfluoran, 3-diethylamino-7-t-butylfluoran, 3-diethylamino-7-carboxyethylfluoran, 3-diethylamino-7-(dibenzylamino)fluoran, 3-dibutylamino-7-dibenzylaminofluoran, 3-diethylamino-6-methylfluoran, 3-diethylamino-6-methyl-7-(4-n-octylanilino)fluoran, 3-diethylamino7-(4-n-octylanilino)fluoran, 3-diethylamino-7-(4-n-octylamino)fluoran.

The above colour forming compounds may be used as single compounds or in combination with each other or further colour forming compounds.

Some preferred colour formers are shown in the following table:

| No. | Colour former | Shade |
|---|---|---|
| 1 | 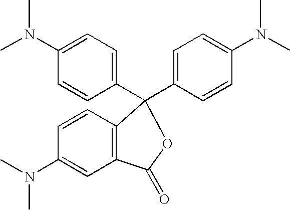 | blue |
| 2 | 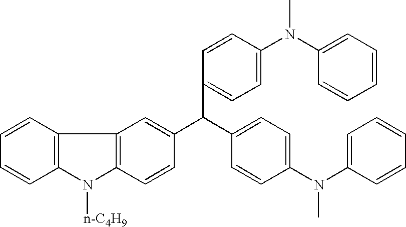 | blue |
| 3 | 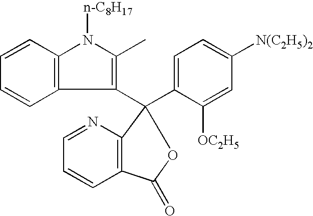 | blue |
| 4 | 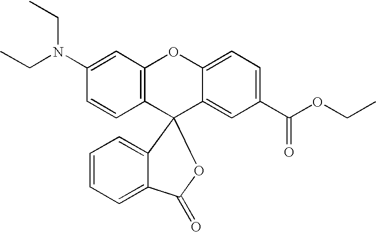 | orange |
| 5 | 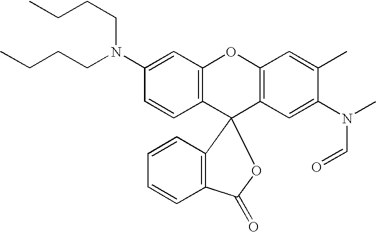 | yellow |
| 6 | 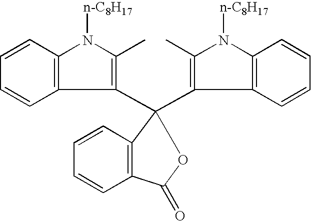 | red |
| 7 | 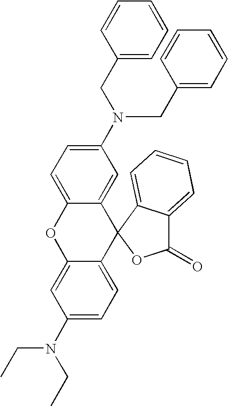 | Green |
| 8 | 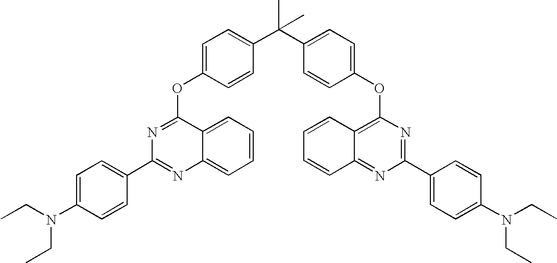 | yellow |

The polymeric material usually contains 0.001 to 10% by weight, preferably 0.01 to 5% by weight of the phenolic antioxidant and/or phenolic UVA. Of special technical importance is a loading of about 0.3 to 3% by weight of the phenolic antioxidant and/or phenolic UVA (all weight percentages relative to the total weight of the polymeric material). The polymeric material can contain mixtures of two or more of the phenolic antioxidant and/or phenolic UVAs.

The amount of colour former in the polymeric material usually is in the range of about 0.001 to 10% by weight, most preferably 0.01 to 5% by weight of the colour former with respect to the total weight of the polymeric material. The polymeric material can contain mixtures of two or more colour formers.

The ratio of phenolic antioxidant and/or phenolic UVA (a) to colour former (b) can e.g. be in the range of 0.01 to 100 parts of colour former (b) per part of phenolic antioxidant and/or phenolic UVA (a); most preferred is about 0.1 to 10 parts of colour former (b) per part of phenolic antioxidant and/or phenolic UVA (a).

The polymeric material, the colour former and the phenolic antioxidant and/or phenolic UVA usually form a homogenous mixture. For specific applications, however, compositions can be made in which the phenolic antioxidant and/or phenolic UVA and the colour former are enriched in a part of the polymeric material, e.g. in the surface areas.

The components of the invention and optional further additives may be added to the polymer material individually or mixed with one another. The incorporation of the components of the invention and optional further components into the polymer is carried out by known methods such as dry blending in the form of a powder, or wet mixing in the form of solutions, dispersions or suspensions for example in an inert solvent, water or oil. The additives of the invention and optional further additives may be incorporated, for example, before or after molding. They may be added directly into the processing apparatus (e.g. extruders, internal mixers, etc), e.g. as a dry mixture or powder or as solution or dispersion or suspension or melt.

The incorporation can be carried out in any heatable container equipped with a stirrer, e.g. in a closed apparatus such as a kneader, mixer or stirred vessel. The incorporation is preferably carried out in an extruder or in a kneader. It is immaterial whether processing takes place in an inert atmosphere or in the presence of oxygen. The process is preferably carried out in an extruder by introducing the additive during processing.

Particularly preferred processing machines are single-screw extruders, contrarotating and corotating twin-screw extruders, planetary-gear extruders, ring extruders or cokneaders. It is also possible to use processing machines provided with at least one gas removal compartment to which a vacuum can be applied.

Suitable extruders and kneaders are described, for example, in Handbuch der Kunststoffextrusion, Vol. 1 Grundlagen, Editors F. Hensen, W Knappe, H. Potente, 1989, pp. 3-7, ISBN:3446-143394 (Vol. 2 Extrusionsanlagen 1986, ISBN 3446-14329-7).

For example, the screw length is 1-60 screw diameters, preferably 35-48 screw diameters. The rotational speed of the screw is preferably 10-600 rotations per minute (rpm), very particularly preferably 25-300 rpm.

The maximum throughput is dependent on the screw diameter, the rotational speed and the driving force. The process of the present invention can also be carried out at a level lower than maximum throughput by varying the parameters mentioned or employing weighing machines delivering dosage amounts.

If a plurality of components are added, these can be premixed or added individually.

One or more components of the invention and optional further additives can also be sprayed onto the polymer material. They are able to dilute other additives (for example the conventional additives indicated below) or their melts so that they can be sprayed also together with these additives onto the material. Addition by spraying during the deactivation of the polymerization catalysts may be particularly advantageous; in this case, the steam evolved may be used for deactivation of the catalyst. In the case of spherically polymerized polyolefins it may, for example, be advantageous to apply the additives of the invention, optionally together with other additives, by spraying.

The components of the invention and optional further additives can also be added to the polymer in the form of a masterbatch (“concentrate”) which contains the components in a concentration of, for example, about 1% to about 40% and preferably 2% to about 20% by weight incorporated in a polymer. The polymer must not be necessarily of identical structure than the polymer where the components are added finally. In such operations, the polymer can be used in the form of powder, granules, solutions, suspensions or in the form of latices.

Incorporation can take place prior to or during the shaping operation, or by applying the dissolved or dispersed compound to the polymer, with or without subsequent evaporation of the solvent in the case of elastomers, these can also be stabilized as latices. A further possibility for incorporating the components of the invention into polymers is to add them before, during or directly after the polymerization of the corresponding monomers or prior to crosslinking. In this context the components of the invention can be added as it is or else in encapsulated form (for example in waxes, oils or polymers).

The materials containing the components of the invention described herein are preferably used for the production of plastic articles such as moldings, rotomolded articles, injection molded articles, blow molded articles, films, tapes, mono-filaments, fibers, textiles, nonwovens, profiles, but also for the production of adhesives or putties, surface coatings and the like. Transparent materials are especially preferred.

Depending on the irradiation source used, the invention provides a method for inducing uniform coloration or coloration of specific regions of the polymeric article. Thus, uniformly coloured materials may be obtained as well as labeled articles or images on or in the article.

It is e.g. possible, to dissolve the components in a solvent and then to remove the solvent by evaporation. Another possibility is to melt polymeric material together with the colour former and the phenolic antioxidant and/or phenolic UVA to get a homogeneous mixture or to thoroughly knead a mixture of polymeric material, colour former and phenolic antioxidant and/or phenolic UVA.

In another embodiment, the phenolic antioxidant and/or phenolic UVA is grafted on the polymer material by means known in the art. E.g. the phenolic antioxidant (a) is previously converted into a monomer, i.e. by incorporating a functional group of suitable reactivity, or a monomer is used which is functionalized with a phenolic antioxidant group (e.g. present compounds Nos. 129 or 130). This allows a graft polymerization on the existing polymeric material or a copolymerization during the manufacturing the polymeric material.

The polymeric material can contain further ingredients, e.g. stabilizers, antioxidants, softeners etc. as are commonly used for polymeric material, examples are listed below:

1. Further Phenolic Antioxidants

such as alkylated monophenols, alkylthiomethylphenols, hydroquinones and alkylated hydroquinones, tocopherols, for example β-tocopherol, γ-tocopherol, δ-tocopherol and mixtures thereof (vitamin E); hydroxylated thiodiphenyl ethers, alkylidenebisphenols, O-, N- and S-benzyl compounds, hydroxybenzylated malonates, aromatic hydroxybenzyl compounds, triazine compounds, benzylphosphonates, acylaminophenols, esters of β-(3,5-di-tert-butyl-4-hydroxyphenyl)propionic acid with mono- or polyhydric alcohols, esters of β-(5-tert-butyl-4-hydroxy-3-methylphenyl)propionic add with mono- or polyhydric alcohols, esters of β-(3,5-dicyclohexyl-4-hydroxyphenyl)propionic acid with mono- or polyhydric alcohols, esters of 3,5-di-tert-butyl-4-hydroxyphenyl acetic acid with mono- or polyhydric alcohols, amides of β-(3,5-di-tert-butyl hydroxyphenyl)propionic acid, ascorbic add (vitamin C).

1.2. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxy-diphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoyl-aminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octylphenothiazines, N-allylphenothiazine, N,N,N′,N′-tetraphenyl-1,4-diaminobut-2-ene, N,N-bis-(2,2,6,6-tetramethyl-piperid-4-yl-hexamethylenediamine, bis(2,2,6,6-tetramethylpiperid-4-yl)-sebacate, 2,2,6,6-tetramethylpiperidin-4-one, 2,2,6,6-tetramethylpiperidin-4-ol.

2. UV Absorbers and Light Stabilisers

2.1. 2-(2′-Hydroxyphenyl)benzotriazoles, for example 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-see-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazole-2-ylphenol]; the transesterification product of 2-[3′-tert-butyl-5′-(2-methoxycarbonylethyl)-2-hydroxyphenyl]-2H-benzotriazole with polyethylene glycol 300; [R—CH₂CH₂—COO—CH₂CH₂ [symbol] ₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]benzotriazole; 2-[2′-hydroxy-3′-(1,1,3,3-tetramethylbutyl)-5′-(α,α-dimethylbenzyl)phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxycinnamate, methyl α-carbomethoxy-p-methoxycinnamate and N-(β-carbomethoxy-β-cyanovinyl)-2-methylindoline.

2.5. Nickel compounds, for example nickel complexes of 2,2′-thiobis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyllauroyl-5-hydroxypyrazole, with or without additional ligands.

2.6. Sterically hindered amines, for example bis(2,2,6,6-tetramethyl-4-piperidyl)sebacate, bis(2,2,6,6-tetramethylpiperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, 5-(2-ethylhexanoyl)-oxymethyl-3,3,5-trimethyl-2-morpholinone, 1-(2-hydroxy-2-methylpropoxy)-4-octadecanoyloxy-2,2,6,6-tetramethylpiperidine, 1,3,5-tris(N-cyclohexyl-N-(2,2,6,6-tetramethylpiperazin-3-on-4-yl)amino)-s-triazine, 1,3,5-tris(N-cyclohexyl-N-(1,2,2,6,6-pentamethylpiperazin-3-on-4-yl)amino)-s-triazine, the reaction product of 2,4-bis[(1-cyclohexyloxy-2,2,6,6-piperidin-4-yl)butylamino]+chloro-s-triazine with N,N′-bis(3-aminopropyl)ethylenediamine), a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as, 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide; N-(1,2,2,6,6-pentamethyl-4-piperidyl)-n-dodecylsuccinimide; 2-undecyl-7,7,9,9-tetramethyl-1-oxa-3,8-diaza-4-oxo-spiro[4,5]decane; 5-(2-ethylhexanoyl)oxymethyl-3,3,5-trimethyl-2-morpholinone; a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine.

2.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythrtol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)-pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo-[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

The following phosphites are especially preferred:
Tris(2,4-di-tert-butylphenyl) phosphite (Irgafos® 168, Ciba Speciality Chemicals), tris(nonylphenyl) phosphite, 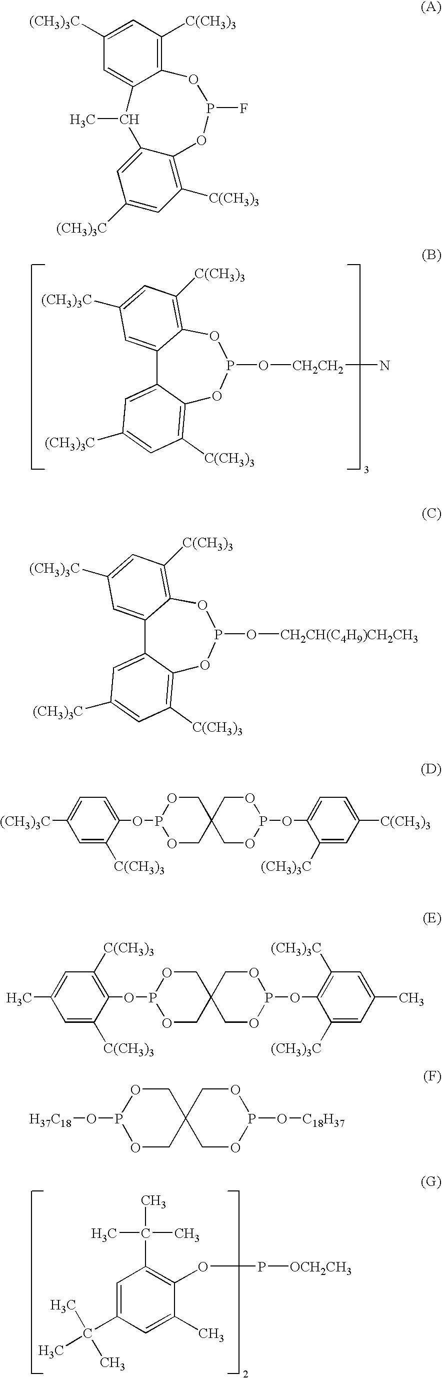
5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.
6. Nitrones, for example N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.
7. Thiosynergists, for example dilauryl thiodipropionate or distearyl thiodipropionate.
8. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.
9. Polyamide stabilisers, for example copper salts in combination with iodides and/or phosphorus compounds and salts of divalent manganese.
10. Basic co-stabilisers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.
11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers).

Especially preferred are 1,3:2,4-bis(3′,4′-dimethylbenzylidene)sorbitol, 1,3:2,4-di(paramethyldibenzylidene)sorbitol, and 1,3:2,4-di(benzylidene)sorbitol.

12. Fillers and reinforcing agents, for example calcium carbonate, silicates, glass fibres, glass beads, asbestos, talc, kaolin, mica, barium sulfate, metal oxides and hydroxides, carbon black, graphite, wood flour and flours or fibers of other natural products, synthetic fibers.

13. Other additives, for example plasticisers, lubricants, emulsifiers, pigments, rheology additives, catalysts, flow-control agents, optical brighteners, flameproofing agents, antistatic agents and blowing agents.

14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839 or EP-A-0591102 or 3-[4-(2-acetoxyiethoxy)-phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one, 3-(2,3-dimethylphenyl)-5,7-di-tert-butyl-benzofuran-2-one.

To convert the phenolic antioxidant and/or phenolic UVA into the acid the polymeric material is irradiated. An irradiation source especially useful for marking in this application is UV-light and especially UV-lasers. The lasers used are commercially available. The wavelength of the UV-light preferably is in the range of 285 to 400 nm, more preferably in the range of 285 to 370 nm. The duration of irradiation depends on the components and on the type of UV-source and may easily be determined by routine experiments.

In case that another high-energy radiation source is used, the phenolic antioxidant and/or phenolic UVAs of component (a) described above may be replaced in the present coloring method by another phenolic compound showing activity as latent acid; examples are compounds of the formula (X) or compounds of formulae (2) to (14) described above. Thus, the present invention further pertains to a method of coloring a polymeric material, wherein a polymeric material containing

c) a phenolic antioxidant, phenolic UVA and/or a latent acid, and

d) a colour former

is irradiated using a radiation of higher energy than ultraviolet light.

Suitable radiation of higher energy than UV light includes X-ray, γ-ray, or particle radiation such as electron beam. Preferred radiation sources include X-ray or electron radiation sources and radioactive materials emitting α-, β- and/or γ-radiation.

Preferred as component (c) are basically the preferred phenolic antioxidants and/or phenolic UVAs (a) described above, or compounds of the formulae (X) and (2) to (14) described above. Most preferred component (c) in this process are compounds (101)-(133) along with compound No. (13) listed above. Colour formers of component (d) are basically the same as those of component (b) noted above. Dosages of components (c) and (d), preferred polymeric materials and uses thereof are also as initially described.

The systems described in this invention may be used as irreversible markers.

The invention also relates to clothes containing the components of the present invention. Such clothes will indicate external irradiation by an irreversible color change, e.g. when such clothes are sterilized for instance by gamma-irradiation. Another instance is the use of such clothes in nuclear power stations and nuclear recovery/storage buildings, as protection clothes, e.g. for working staff or civil defense personnel, in case of accident or nuclear attack.

A specific embodiment is an ABC protective clothing containing a polymer material with components (a) and (b) or (c) and (d) of present invention on or visibly below (e.g. covered by a transparent cover layer) its surface, wherein the coloring is effected on irradiation or contact with radioactive material.

Clothes can be based on synthetic or natural fibers. Examples for synthetic fiber materials are well known in the state-of-the-art, e.g. polyester, polyamide, polypropylene, elastane, polyurethane, polyaramide, polyacryl, or other materials known in the art. The fibers are pro-produced mainly in a melt process (fiber spinning) where the inventive compositions can be added. As a result the complete fiber will change the color, when irradiated. These fibers can be used for making a fabric. These fabrics are suitable for the above mentioned clothes. It is also possible to combine synthetic and natural (like cotton, wool, etc.) fibers into one fabric. Moreover, functional clothes may combine several functionalities, which are based on separate fabric layers. The fabric according to the invention is preferably used on an external, visible part of the complete clothes.

The invention also relates to a process of making a fiber or woven or non-woven fabric, which process comprises adding (a) a phenolic antioxidant and/or phenolic UVA and (b) a colour former to a synthetic polymer before or during the fiber melt spinning process.

These materials or films or plates containing current components (a) and (b) are further useful as tags indicating x-ray or radioactive irradiation. Intensity of irradiation may be monitored by observation of colour development or by comparison of the colour of the irradiated tag or sample with the colour of a tag or sample not irradiated. Thus, present invention further provides a process for monitoring irradiation by X-ray or radioactive material, which process comprises placing a tag or sample of a polymer material comprising components (a) and (b) or (c) and (d) described above in a site to be controlled, and subsequently checking the colour of the tag or sample.

The following non-limitative examples illustrate the invention in more detail. Parts and percentages are by weight, unless otherwise stated.

### EXAMPLE 1

Formulations: 12 g of colour former (3,3-bis(p-dimethylaminophenyl)-6-dimethylaminophthalide) and 12 g of the phenolic antioxidant pentaerythritol tetrakis(3-(3,5-di-tert-butyl-4-hydroxyphenyl)propionate) (available as Irganox® 1010, Ciba Specialty Chemicals) are mixed in a turbomixer with 1176 g of polypropylene powder (PP, Moplen® JE 6100, Basell) having a melt index of 3.0 (measured at 230° C. and 2.16 Kg).

The mixture is extruded at 200-230° C. to give polymer granules which are subsequently converted into plaques 1 mm thick, using an injection molding machine (Negribossi—Italy) and working at a maximum temperature of 220° C.

The same procedure is applied for formulations 2, 3 and 4 with the amounts reported in Table 1.

TABLE 1
Formulations used

| Formulation | Colour Former | | Phenolic antioxidant | | PP |
|---|---|---|---|---|---|
| No. | % | g | % | g | g |
| 1 | 1 | 12 | 1 | 12 | 1176 |
| 2 | 0.1 | 1.2 | 0.1 | 1.2 | 1197.6 |
| 3 | 1 | 12 | 0.1 | 1.2 | 1186.8 |
| 4 | 0.1 | 1.2 | 1 | 12 | 1186.8 |

UV laser imaging: A polypropylene plaque (formulation as in the above Table 1) is irradiated using a Lasertec® UV laser system operating at 355 nm, 3 kHZ, 99.9% power and a scan speed of 15 mm/sec. Once imaging is complete, text is clearly visible on the plaque. Repeated imaging leads to more intense image. The plaque is then subjected to artifical daylight for 67 hours on a light rig with an average output of 13,000 Lux. No significant change in the density of the imaged text is discernible. The optical density and L*a*b* values (CIELAB) of the unimaged background of the plaque are measured before and after exposure to artificial daylight using a Gretag® SPM50 spectrophotometer. Formulations 2-4 as in the above Table 1 are tested in the same way. The results are compiled in Table 2.

TABLE 2
Optical density and L*, a*, b* parameters of unimaged
background before and after exposure to artificial daylight

| Formula- | | | | | | | | |
|---|---|---|---|---|---|---|---|---|
| tion | ODₘₐₓ | | L* | | | L* | | |
| No. | Before | After | Before | a* | b* | After | a* | b* |
| 2 | 0.28 | 0.31 | 86.95 | 0.16 | 8.30 | 85.03 | 0.35 | 8.25 |
| 4 | 0.26 | 0.31 | 87.60 | 0.18 | 8.10 | 84.76 | 0.95 | 8.26 |
| 1 | 0.59 | 0.69 | 70.00 | 3.66 | 5.19 | 69.75 | 3.19 | 8.65 |
| 3 | 0.56 | 0.74 | 71.67 | 3.84 | 5.08 | 69.20 | 3.17 | 9.81 |

Images obtained as coloration on unirradiated background show good contrast and light stability.

### EXAMPLE 2

15 g of colour former (3,3-bis(p-dimethylaminophenyl)-6-methylaminophthalide) and 7.5 g of [2-hydroxy(octyloxy)phenyl]phenyl-methanone (compound E) are mixed in a turbomixer with 1477 g of polypropylene powder (PP, Moplen® JE 6100, Basell) having a melt index of 3.0 (measured at 230° C. and 2.16 Kg).

The mixture is extruded at 200-230° C. to give polymer granules which are subsequently converted into plaques 1 mm thick, using an injection molding machine (Negribossi—Italy) and working at a maximum temperature of 220° C.

The same procedure is applied for formulations 2 and 3 where different phenolic UV absorbers are used as colour developer, with the amounts reported in Table 3.

Compound F is 2,4-di-tert-butyl-6-(5-chlorobenzotriazol-2yl)phenol, and compound G is 2-(4,6-bis-biphenyl-4-yl-[1,3,5]triazin-2-yl)-5-(2-ethyl-hexyloxy)-phenol.

TABLE 3
Formulations used

| Formulation | Colour former | | UV absorber | | | PP |
|---|---|---|---|---|---|---|
| no. | % | g | type | % | g | g |
| 1 | 1 | 15 | Compound E | 0.5 | 7.5 | 1477 |
| 2 | 1 | 15 | Compound F | 0.5 | 7.5 | 1477 |
| 3 | 1 | 15 | Compound G | 0.5 | 7.5 | 1477 |

Gamma ray imaging: A polypropylene plaque (formulation as in the above Table 3) is irradiated using a gamma ray source with irradiation power of 20 KGy. Once imaging is complete, the plaque shows significant change in the colour. L*a*b* values (CIELAB) of the plaque are measured before and after exposure to γ ray source, using a Minolta® CM-508 d Colorimeter. Formulations 2-3 in Table 3 are tested in the same way. The results are compiled in Table 4.

TABLE 4
L*, a*, b* parameters of plaques before and after γ ray imaging

| Formulation | L* | | | L* | | |
|---|---|---|---|---|---|---|
| No. | Before | a* | b* | After | a* | b* |
| 1 | 88.2 | −2.53 | 4.58 | 75.7 | 0.94 | 6.87 |
| 2 | 88.06 | −2.54 | 4.68 | 75.7 | 0.68 | 11.65 |
| 3 | 87.44 | −10.03 | 25.92 | 74.9 | −1.06 | 19.31 |

The visual assessment of the colours obtained is reported in Table 5.

TABLE 5
Colour of the plaques before and after γ ray imaging

| Formulation | Before | After |
|---|---|---|
| 1 | Slight yellow | Gray |
| 2 | Slight yellow | Gray |
| 3 | Slight yellow | Deep gray |

As it be seen form both the instrumental and the visual assessment, remarkable change in the colour of the plaques containing UV absorbers is brought about by the gamma ray treatment, so that the plaques show different colour from the un-imaged ones.

### EXAMPLE 3

### PC injection Molding Samples

4000 g of polycarbonate (PC; Lexan® 145) powder is dried in a vacuum oven at 100 mm Hg and 120° C. for at least 6 hours, then mixed on a high speed mixer Henschel® FM/L 10 at 75° C. with 3.36 g of tris(2,4-di-tert-butylphenyl)phosphite (compound 20), 2.0 g of 1,1,3-tris(2-methyl-4-hydroxy-5-tert-butyl phenyl)butane (compound 13) and 2.0 g of colour former A (3,3-bis(p-dimethylaminophenyl)-6-dimethylaminophthalide) and compounded on a Berstorff® ZE 25×32D at 280° C. The pellets are dried for at least 6 hours in a vacuum oven at 120° C. and 100 mm Hg and then injection molded at 300° C. on a Engel® EK 65 injection molding machine to 2 mm thick plaques. The samples are exposed to 20 kGy electron beam (e-beam) radiation.

The procedure is applied for all the other formulations mentioned in Table 6. The colour before and after the e-beam treatment is measured with a Spektraflash® SF 600 Plus. The results are compiled in Table 7.

Colour former B is 3-diethylamino-7-carboxyethyl fluoran. Colour former C is bis(N-methyldiphenylamine)-4-yl-(N-butylcarbazole)-3-yl-methane. Colour former D is 3-diethylaminobenzo[a]fluoran. Colour former E is 3-diethylamino-6,8-dimethylfluoran.

TABLE 6
Formulations PC Plaques e-beam

| Formu- | | Colour | Phenolic | Base |
|---|---|---|---|---|
| lation | Polymer | former | antioxidant | stabilizer |
| 1 | 4 kg PC | 1.5 g Colour | 1.5 g | 3.36 g |
| | | former A | Compound 13 | Compound 20 |
| 2 | 4 kg PC | 2.0 g Colour | 2.0 g | 3.36 g |
| | | former A | Compound 13 | Compound 20 |
| 3 | 4 kg PC | 4.0 g Colour | 4.0 g | 3.36 g |
| | | former A | Compound 13 | Compound 20 |
| 4 | 4 kg PC | 1.5 g Colour | 1.5 g | 3.36 g |
| | | former B | Compound 13 | Compound 20 |
| 5 | 4 kg PC | 2.0 g Colour | 2.0 g | 3.36 g |
| | | former B | Compound 13 | Compound 20 |
| 6 | 4 kg PC | 4.0 g Colour | 4.0 g | 3.36 g |
| | | former B | Compound 13 | Compound 20 |
| 7 | 4 kg PC | 2.0 g Colour | 4.0 g | 3.36 g |
| | | former A + | Compound 13 | Compound 20 |
| | | 2.0 g Colour | | |
| | | former B | | |
| 8 | 3 kg PC | 3.15 g Colour | 3.15 g | 2.52 g |
| | | former C | Compound 13 | Compound 20 |
| 9 | 3 kg PC | 3.15 g Colour | 3.15 g | 2.52 g |
| | | former D | Compound 13 | Compound 20 |
| 10 | 3 kg PC | 3.15 g Colour | 3.15 g | 2.52 g |
| | | former E | Compound 13 | Compound 20 |
| Refer- | 4 kg PC | — | — | 3.36 g |
| ence | | | | Compound 20 |

TABLE 7
Colour values before and after e-beam treatment

| Formula- | | | | | | |
|---|---|---|---|---|---|---|
| tion | Before e-beam | | | After e-beam | | |
| No. | L* | a* | b* | L* | a* | b* |
| 1 | 97.5 | −0.9 | 4 | 87.8 | −9 | 9.2 |
| 2 | 97.7 | −0.9 | 3.9 | 84.7 | −11.5 | 5.4 |
| 3 | 97.2 | −1.3 | 5.8 | 81.9 | −13.7 | 5.5 |
| 4 | 97.9 | −1 | 3.9 | 91.6 | 1.1 | 19.6 |
| 5 | 97.8 | −0.9 | 3.7 | 90.9 | 1.7 | 21.5 |
| 6 | 97.2 | −0.7 | 4.3 | 88.2 | 6.1 | 25.8 |
| 7 | 97.4 | −1.3 | 5.4 | 82.8 | −6.8 | 13.2 |
| 8 | 93.7 | 2.2 | 13.1 | 70.7 | −15.6 | 2.6 |
| 9 | 97.6 | −0.6 | 3.8 | 77.6 | 29.1 | 3.5 |
| 10 | 97.4 | −0.1 | 6.2 | 85.9 | 17.9 | 26.1 |
| Ref. | 97.7 | −0.7 | 2.5 | 94.6 | −3.1 | 13.2 |

Visual aspect of the samples before and after the e-beam treatment is reported in Table 8.

TABLE 8
Visual aspects of PC plaques

| Formulation | Colour before e-beam | Colour after e-beam |
|---|---|---|
| 1 | Slightly yellow | Blue |
| 2 | Slightly yellow | Blue |
| 3 | Slightly yellow | Blue |
| 4 | Slightly yellow | Slightly orange |
| 5 | Slightly yellow | Orange |
| 6 | Slightly yellow | Deep orange |
| 7 | Slightly yellow | Brown |
| 8 | Slightly yellow | Blue |
| 9 | Colorless | Pink |
| 10 | Slightly yellow | Orange |
| Reference | Slightly yellow | Slightly yellow |

The samples are also imaged using a UV laser operating at 355 nm, 20 Khz with pulse energy of 80 μJ/pulse. In each case similar colours as in Table 8 are observed.

### EXAMPLE 4

### PMMA Injection Molded Samples

2500 g of poly(methyl methacrylate) (PMMA; Plexiglas® 7N) is dried in a vacuum oven at 100 mm Hg at 80° C. for 8 hours, mixed with 1.31 g of colour former A (3,3-bis(p-dimethylaminophenyl)-6-dimethylaminophthalide), 1.31 g of 1,1,3-tris(2-methyl-4-hydroxy-5-tert-butyl phenyl)butane (compound 13) and 3.94 g of compound 21 (80% tris(2,4-di-tert-butylphenyl)phosphite/20% octadecyl-3-(3,5-di-tert-butyl-4-hydroxyphenyl)-propionate) on a high speed mixer MTI®/M35 FU, compounded at 230° C. on a Berstorff® ZE 25×32D twin screw extruder and after drying at 80° C./100 mm Hg for 2 hours and injection molded at 255° C. on a Engel® HL 65 to 2 mm thick plaques. The samples are exposed to 20 kGy electron beam (e-beam) radiation.

The same procedure is applied for all the other formulations mentioned in Table 9. The colour before and after the e-beam treatment is measured with a Spektraflash® SF 600 Plus. The results are compiled in Table 10.

Colour former B is 3-diethylamino-7-carboxyethyl fluoran. Colour former C is bis(N-methyldiphenylamine)-4-yl-(N-butylcarbazole)-3-yl-methane.

TABLE 9
Formulations PMMA Plaques e-beam

| Formula- | | | Stabilizers/Phenolic | |
|---|---|---|---|---|
| tion | Polymer | Colour former | antioxidants | |
| 1 | 2.5 kg | 1.31 g Colour | 1.31 g | 3.94 g |
| | PMMA | former A | Compound 13 | Compound 21 |
| 2 | 2.5 kg | 1.31 g Colour | 1.31 g | 3.94 g |
| | PMMA | former B | Compound 13 | Compound 21 |
| 3 | 2.5 kg | 1.31 g Colour | 1.31 g | 3.94 g |
| | PMMA | former C | Compound 13 | Compound 21 |
| Refer- | 2.5 kg | | | 3.94 g |
| ence | PMMA | | | Compound 21 |

TABLE 10
Colour values before and after e-beam treatment

| Formul. | Before e-beam | | | After e-beam | | |
|---|---|---|---|---|---|---|
| No. | L* | a* | b* | L* | a* | b* |
| 1 | 97.9 | −0.1 | 0.1 | 75.3 | −11.3 | −2.4 |
| 2 | 97.4 | −0.1 | 1.6 | 82.3 | 12.6 | 55.6 |
| 3 | 93.1 | −2.6 | −4.7 | 77.2 | −17.2 | 15.5 |
| Refer- | 97.6 | −0.3 | 1 | 96 | −2.3 | 7.6 |
| ence | | | | | | |

Visual aspect of the samples before and after the e-beam treatment is reported in Table 11.

TABLE 11
Visual aspects of PMMA plaques

| Formulation | Colour before e-beam | Colour after e-beam |
|---|---|---|
| 1 | Colorless | Blue-purple |
| 2 | Colorless | Orange |
| 3 | Colorless | Blue-brown |
| Reference | Colorless | Colorless |

The samples are also imaged using a UV laser operating at 355 nm, 20 Khz with pulse energy of 80 μJ/pulse. In each case similar colours as in Table 11 are observed.

1. Method of coloring a polymeric material, wherein a polymeric material containing
a) a phenolic antioxidant and/or a phenolic ultraviolet absorber and
b) a colour former
is irradiated using a radiation of higher energy than visible light, provided that the phenolic antioxidant and/or phenolic ultraviolet absorber (a) is not a compound of the formula (2) to (14)

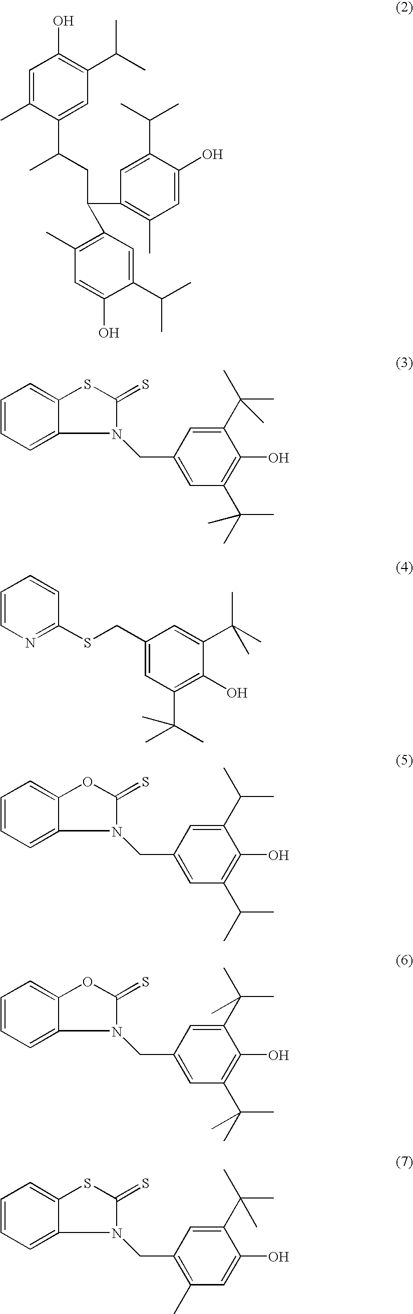

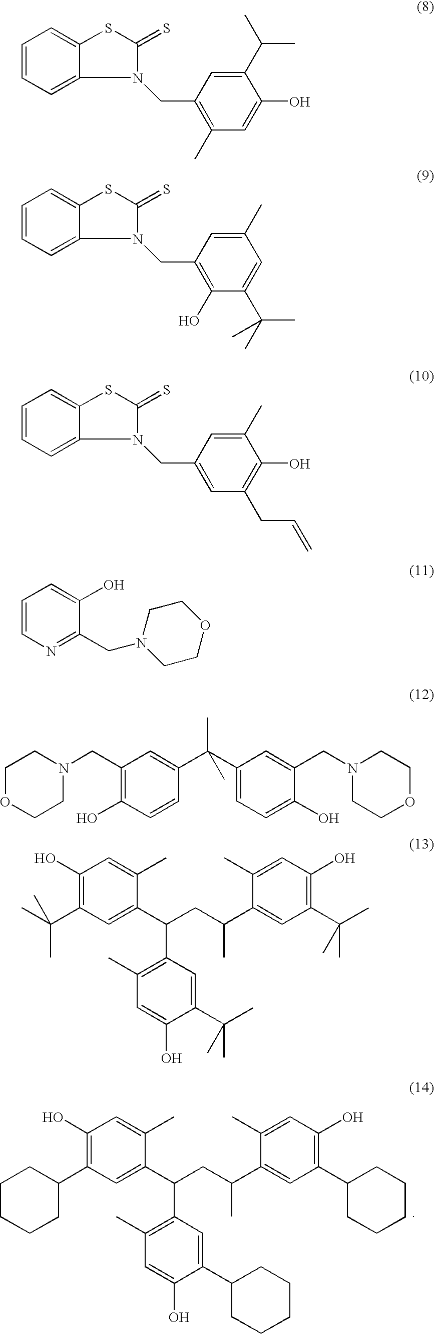

2. Method according to claim 1, wherein the radiation of higher energy than visible light is selected from ultraviolet light, X-ray, gamma radiation and particle radiation.

3. Method according to claim 1, wherein component (a) is a compound comprising one or more mono-hydroxyphenyl moieties, each carrying one or two bonds to either a linking group connecting the moiety with 1 to 3 further moieties of the same type or to an anchor group,
and optionally 1-3 further substituents selected from alkyl of 1 to 12 carbon atoms,
where the linking groups are di-, tri- or tetravalent aliphatic groups of 1 to 20 carbon atoms and
divalent linking groups are selected from
alkylene which may be interrupted and/or end-capped with —O—, —NH—, —S—, —CO—, —COO—, —OCO—, —NHCO—, —CONH—, a group L₁, phenylene or phenylene which is substituted by C₁-C₁₂alkyl and/or C₁-C₁₂alkoxy and/or C₂-C₁₂alkanoyloxy and/or C₃-C₁₂alkenoyloxy;
divalent mono-, di- or tricycloalkylene groups; divalent mono-, di- or tricycloalkylene groups interrupted by —O—; —O—; —NH—; —S—; —CO—; —COO—; —OCO—; —NHCO—; and —CONH—;
trivalent groups are selected from
trivalent alkyl groups of 3 to 20 carbon atoms; said trivalent alkyl groups interrupted and/or end-capped with —O—, —NH—, —S—, —CO—, —COO—, —OCO—, —NHCO—, —CONH—, a group L₁, phenylene or phenylene which is substituted by C₁-C₁₂alkyl and/or C₁-C₁₂alkoxy and/or C₂-C₁₂alkanoyloxy and/or C₃-C₁₂alkenoyloxy; and trivalent groups of the formulae 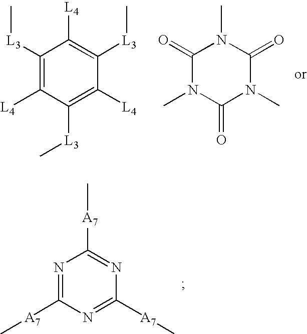
tetravalent groups are selected from
tetravalent alkyl groups of 4 to 20 carbon atoms; and said tetravalent alkyl groups interrupted and/or end-capped with —O—, —NH—, —S—, —CO—, —COO—, —OCO—, —NHCO—, —CONH—, a group L₁, phenylene or phenylene which is substituted by C₁-C₁₂alkyl and/or C₁-C₁₂alkoxy and/or C₂-C₁₂alkanoyloxy and/or C₃-C₁₂alkenoyloxy;
wherein
L₁ is a group selected from the formulae 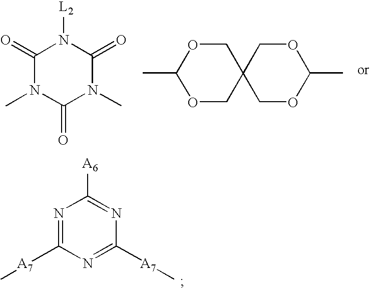
L₂ is OH, C₁-C₁₂alkyl, C₁-C₁₂alkoxy, C₂-C₁₂hydroxyalkyl; or C₂-C₁₂hydroxyalkoxy;
L₃ independently are C₁-C₄alkylene;
L₄ independently are H or C₁-C₄alkyl; and
anchor groups are selected from
C₁-C₂₂alkyl; C₁-C₂₂alkyl-A₅-; C₂-C₂₂alkyl interrupted by -A₅-; -A₄-phenyl; -A₄-phenyl where the phenyl core is substituted by C₁-C₁₂alkyl, C₁-C₁₂alkoxy, C₂-C₁₂alkanoyloxy and/or C₃-C₁₂alkenoyloxy;
C₁-C₈alkyl substituted by a group of the formula 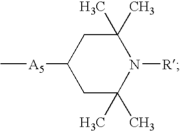
and phosphite, phosphate or phosphonate ester groups of the formula
-A₃-(O)ₘ—P(═O)ₚ(OA₁)(OA₂);
or the anchor group is of the formula 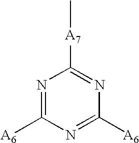
where m and p independently are 0 or 1;
A₁ and A₂ independently are C₁-C₁₂alkyl or phenyl or phenyl substituted by C₁-C₁₂alkyl or an equivalent of an alkaline, alkaline earth or aluminum atom;
A₃ is a direct bond or C₁-C₈alkylene;
A₄ is selected from C₁-C₈alkylene and A₅;
A₅ is selected from —O—, —NH—, —S—, —CO—, —COO—, —OCO—, —NHCO— and —CONH—;
A₆ is selected from C₁-C₁₈alkoxy, C₁-C₁₈alkylthio and C₁-C₁₈alkylamino;
A₇ is —O— or —NH—;
R′ is H, C₁-C₁₈alkyl, C₁-C₁₈alkoxy or cyclohexyloxy;
or the anchor group is C₃-C₂₂alkylene or C₃-C₂₂oxaalkylene attached with both open bonds to adjacent carbon atoms of the mono-hydroxyphenyl moiety; or
component (a) can also be a phenolic UV absorber compound selected from benzotriazoles of the formula (IIa), 2-hydroxybenzophenones of the formula (IIb) and 2-hydroxyphenyltriazines of formula (IIc): 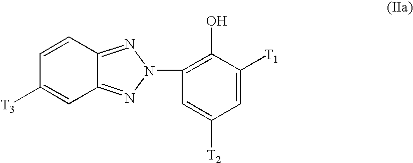
wherein T₁ is hydrogen, C₁-C₁₈alkyl, or C₁-C₁₈alkyl which is substituted by phenyl,
or T₁ is a group of the formula 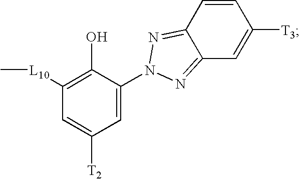
L₁₀ is a divalent group —(CH₂)ₙ—, where n is from the range 1-8;
T₂ is hydrogen, C₁-C₁₈alkyl, or is C₁-C₁₈alkyl which is substituted by COOT₅, C₁-C₁₈alkoxy, hydroxyl, phenyl or C₂-C₁₈acyloxy;
T₃ is hydrogen, halogen, C₁-C₁₈alkyl, C₁-C₁₈alkoxy, C₂-C₁₈acyloxy, perfluoroalkyl of 1 to 12 carbon atoms, or T₃ is phenyl; and
T₅ is C₁-C₁₈alkyl or C₄-C₅₀alkyl interrupted by one or more O and/or substituted by OH or by a group 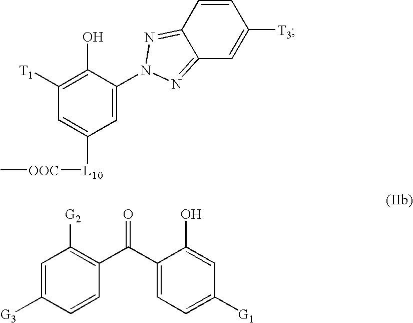
wherein
G₁, G₂ and G₃ independently are hydrogen, hydroxy or C₁-C₁₈alkoxy; 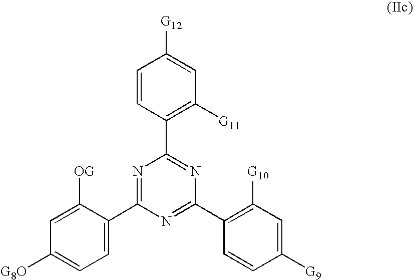
wherein
G₈ is C₁-C₁₈alkyl, or is C₄-C₁₈alkyl which is interrupted by COO or OCO or O, or is interrupted by O and substituted by OH; and
G₉, G₁₀, G₁₁ and G₁₂ independently are hydrogen, methyl, hydroxy or OG₈; and G₉ and G₁₂ also comprise phenyl.

4. Method according to claim 3, wherein the anchor groups are selected from tertiary C₄-C₁₂alkyl; C₁-C₂₂alkyl-A₅-; C₂-C₂₂alkyl interrupted by -A₅-; -A₅-phenyl; -A₅-phenyl where the phenyl core is substituted by C₁-C₁₂alkyl; and -A₄-phenyl where the phenyl core is substituted by C₂-C₁₂alkanoyloxy and/or C₃-C₁₂alkenoyloxy, and optionally further by C₁-C₁₂alkyl; or the anchor group is C₃-C₂₂alkylene or C₃-C₂₂oxaalkylene attached with both open bonds to adjacent carbon atoms of the mono-hydroxyphenyl moiety; or is a group of one the formulae 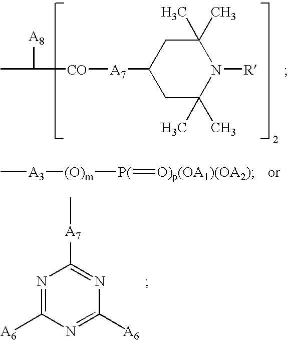
where m and p independently are 0 or 1;
A₁ and A₂ independently are C₁-C₁₂alkyl or phenyl or phenyl substituted by C₁-C₁₂alkyl or an equivalent of an alkaline, alkaline earth or aluminum atom;
A₃ is a direct bond or C₁-C₈alkylene;
A₄ is selected from C₁-C₈alkylene, —O—, —NH—, —S—, —CO—, —COO—, —OCO—, —NHCO— and —CONH—;
A₅ is selected from —O—, —NH—, —S—, —CO—, —COO—, —OCO—, —NHCO— and —CONH—;
A₆ is selected from C₁-C₁₈alkoxy, C₁-C₁₈alkylthio and C₁-C₁₈alkylamino;
A₇ is —O— or —NH—;
A₈ is C₁-C₇alkyl; and
R′ is C₁-C₁₈alkyl.

5. Method according to claim 3, wherein component (a) is a compound of the formula (A) 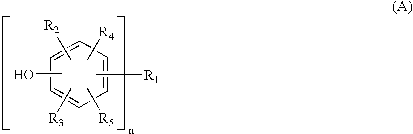
wherein
R₂, R₃, R₄ and R₅ independently are hydrogen, methyl or tertiary C₄-C₁₂alkyl;
n is from the range 1-4:
when n is 1,
R₁ is tertiary C₄-C₁₂alkyl; C₁-C₂₂alkyl-A₅-; C₂-C₂₂alkyl interrupted by -A₅-; -A₅-phenyl; -A₅-phenyl where the phenyl core is substituted by C₁-C₁₂alkyl; -A₄-phenyl where the phenyl core is substituted by C₂-C₁₂alkanoyloxy and/or C₃-C₁₂alkenoyloxy, and optionally further by C₁-C₁₂alkyl; or R₁ together with R₅ is C₃-C₂₂alkylene or C₃-C₂₂oxaalkylene attached with both open bonds to adjacent carbon atoms of the mono-hydroxyphenyl moiety; or is a group of one the formulae 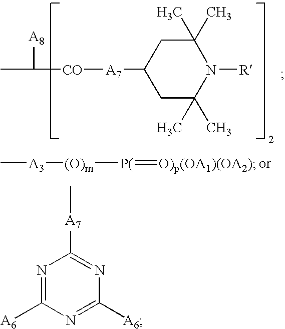
where m and p independently are 0 or 1;
A₁ and A₂ independently are C₁-C₁₂alkyl or phenyl or phenyl substituted by C₁-C₁₂alkyl or an equivalent of an alkaline, alkaline earth or aluminum atom;
A₃ is a direct bond or C₁-C₈alkylene;
A₄ is selected from C₁-C₈alkylene, —O—, —NH—, —S—, —CO—, —COO—, —OCO—, —NHCO— and —CONH—;
A₅ is selected from —O—, —NH—, —S—, —CO—, —COO—, —OCO—, —NHCO— and —CONH—;
A₆ is selected from C₁-C₁₈alkoxy, C₁-C₁₈alkylthio and C₁-C₁₈alkylamino;
A₇ is —O— or —NH—;
A₈ is C₁-C₇alkyl; and
R′ is C₁-C₁₈alkyl;
when n is 2, R₁ is C₁-C₂₀alkylene which may be interrupted and/or end-capped with —O—, —NH—, —S—, —CO—, —COO—, —OCO—, —NHCO—, —CONH—, -L₁-, phenylene, phenylene which is substituted by C₁-C₁₂alkyl and/or C₁-C₁₂alkoxy and/or C₂-C₁₂alkanoyloxy and/or C₃-C₁₂alkenoyloxy;
divalent mono-, di- or tricycloalkylene groups; divalent mono-, di- or tricycloalkylene groups interrupted by —O—; —O—; —NH—; —S—; —CO—; —COO—; —OCO—; —NHCO—; or —CONH—;
when n is 3, R₁ is trivalent alkyl of 3 to 20 carbon atoms; said trivalent alkyl interrupted or end-capped with —O—, —NH—, —S—, —CO—, —COO—, —OCO—, —NHCO—, —CONH—, -L₁-, phenylene or phenylene which is substituted by C₁-C₁₂alkyl and/or C₁-C₁₂alkoxy and/or C₂-C₁₂alkanoyloxy and/or C₃-C₁₂alkenoyloxy;
or trivalent groups of the formulae 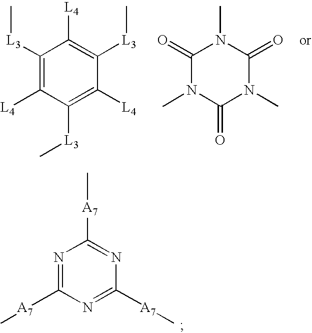
when n is 4, R₁ is tetravalent alkyl of 4 to 20 carbon atoms; said tetravalent alkyl interrupted or end-capped with —O—, —NH—, —S—, —CO—, —COO—, —OCO—, —NHCO—, —CONH—, -L₁-, phenylene or phenylene which is substituted by C₁-C₁₂alkyl and/or C₁-C₁₂alkoxy and/or C₂-C₁₂alkanoyloxy and/or C₃-C₁₂alkenoyloxy;
L₁ is a group selected from the formulae 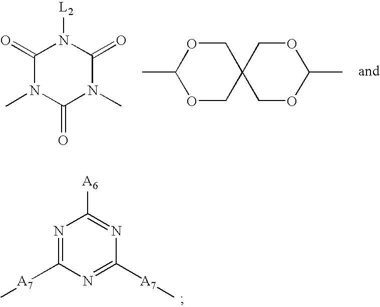
L₂ is OH, C₁-C₁₂alkyl, C₁-C₁₂alkoxy, C₂-C₁₂hydroxyalkyl; or C₂-C₁₂hydroxyalkoxy;
L₃ independently are C₁-C₄alkylene; and
L₄ independently are H or C₁-C₄alkyl.

6. Method according to claim 5, wherein R₂, R₃, R₄ and R₅ independently are hydrogen, methyl, tert-butyl or tert-pentyl;
when n is 1,
R₁ is tertiary butyl, tertiary pentyl; C₁-C₂₂alkyl-A₅-; C₂-C₂₂alkyl interrupted by -A₅-; -A₅-phenyl where the phenyl core is substituted by C₁-C₁₂alkyl; -A₄-phenyl where the phenyl core is substituted by C₃-C₄alkenoyloxy and C₁-C₁₂alkyl; or R₁ together with R₅ is C₃-C₂₂alkylene or C₃-C₂₂oxaalkylene attached with both open bonds to adjacent carbon atoms of the mono-hydroxyphenyl moiety; or R₁ is a group of one the formulae 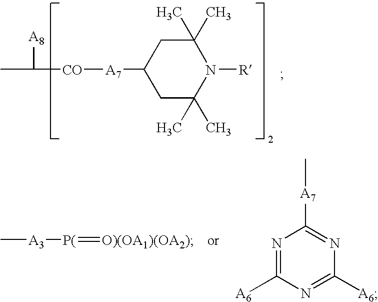
where
A₁ and A₂ independently are C₁-C₄alkyl or an equivalent of a metal atom selected from Li, Na, K, ½ Mg, ½ Ca and ⅓ Al;
A₃ is methylene;
A₄ is C₁-C₈alkylene;
A₅ is selected from —O—, —S—, —COO—, —OCO—, —NHCO— and —CONH—;
A₆ is selected from C₄-C₁₈alkylthio and C₄-C₁₈alkylamino;
A₇ is —NH—;
A₈ is C₁-C₇alkyl; and
R′ is C₁-C₁₈alkyl;
when n is 2, R₁ is C₁-C₁₂alkylene; C₂-C₂₀alkylene interrupted and/or end-capped with —O—, —S—, —COO—, —OCO—, —NHCO—, —CONH— or -L₁-; or R₁ is a divalent mono-, di- or tricycloalkylene group; or R₁ is —O—; —NH—; or —S—;
when n is 3, R₁ is trivalent alkyl of 3 to 20 carbon atoms; said trivalent alkyl interrupted by —O—, —S—, —COO—, —OCO—, —NHCO—, —CONH—, phenylene or phenylene which is substituted by C₁-C₁₂alkyl; or
R₁ is a trivalent group of one of the formulae 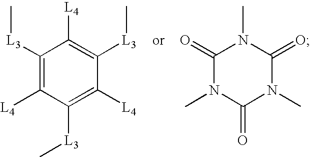
when n is 4, R₁ is tetravalent alkyl of 4 to 20 carbon atoms; or said tetravalent alkyl interrupted by —O—, —S—, —COO—, —OCO—, —NHCO— or —CONH—; and
L₁ is a group of the formula 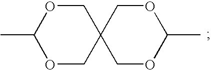
L₃ independently are C₁-C₄alkylene; and
L₄ independently are H or C₁-C₄alkyl.

7. Method according to claim 1, wherein the colour former is a triphenylmethane, lactone, benzoxazine, spiropyran, fluoran or phthalide.

8. Method according to claim 1, wherein the polymeric material contains 0.001 to 10% by weight of the phenolic antioxidant and/or phenolic UVA, based on the total weight of the polymeric material.

9. Method according to claim 1, wherein the polymeric material contains 0.001 to 10% by weight of the colour former with respect to the total weight of the polymeric material.

10. Method according to claim 1, wherein the polymeric material is a transparent thermoplast.

11. Method according to claim 1, wherein the polymeric material is selected from styrene acrylonitrile copolymer, polyolefin, polyvinylchloride, polychlorobutadiene, polyesters or glycol modified polyesters, polyacrylics, polystyrene, acrylonitrile styrene acrylate copolymer, polyamide, acrylonitrile styrene butadiene copolymer, polycarbonate and blends or alloys thereof.

12. Method of coloring a polymeric material, wherein a polymeric material containing
c) a phenolic antioxidant, phenolic ultraviolet absorber and/or a latent acid, and
d) a colour former
is irradiated using a radiation of higher energy than ultraviolet light.

13. Protective clothing or mask or irradiation indicating tag, wherein a polymeric material comprising components (c) and (d) according to claim 12 in the form of a fiber, textile, nonwoven or film is contained on or visibly below the surface of the clothing, mask or tag.

14. Process for monitoring irradiation by X-ray or radioactive material, which process comprises placing a tag or sample of a polymeric material comprising components (c) and (d) according to claim 12 in the site to be controlled, and subsequently checking the colour of the tag or sample.

15. (canceled)

16. Process of making a fiber or woven or non-woven fabric, which process comprises adding (a) a phenolic antioxidant and/or phenolic UVA and (b) a colour former to a synthetic polymer before or during the fiber melt spinning process.

17. Method according to claim 1, wherein the radiation of higher energy than visible light is selected from ultraviolet laser or ultraviolet lamp radiation of 285 to 400 nm, electron radiation, X-ray and gamma radiation.

18. Method according to claim 1, wherein the polymeric material contains 0.01 to 5% by weight of the colour former with respect to the total weight of the polymeric material.
